(19) United States
(12) Patent Application Publication
(10) Pub. No.: US 2024/0012353 A1
(43) Pub. Date: Jan. 11, 2024

(54) IMAGE FORMING APPARATUS

(71) Applicants: Yuusuke FURUICHI, Kanagawa (JP); Takamasa HASE, Kanagawa (JP); Hiroshi SEO, Kanagawa (JP); Hideki SUGIURA, Shizuoka (JP); Maiko KOEDA, Shizuoka (JP); Masahiko ISHIKAWA, Shizuoka (JP)

(72) Inventors: Yuusuke FURUICHI, Kanagawa (JP); Takamasa HASE, Kanagawa (JP); Hiroshi SEO, Kanagawa (JP); Hideki SUGIURA, Shizuoka (JP); Maiko KOEDA, Shizuoka (JP); Masahiko ISHIKAWA, Shizuoka (JP)

(73) Assignee: Ricoh Company, Ltd., Ohta-ku, Tokyo (JP)

(21) Appl. No.: 18/254,969

(22) PCT Filed: Dec. 23, 2021
(86) PCT No.: PCT/JP2021/047808

§ 371 Date: May 30, 2023

(30) Foreign Application Priority Data
Dec. 24, 2020 (JP) 2020-214930

(51) Int. Cl. G03G 15/20

(52) U.S. Cl. CPC G03G 15/2057; G03G 15/2064; G03G 15/2039; G03G 2215/2032

(57) ABSTRACT

Provided is an image forming apparatus including a toner, and a fixing device configured to fix an image formed with the toner on a recording medium. The fixing device includes a fixing belt that is an endless belt, and a planar member configured to heat the fixing belt. An environmental fluctuation rate X is 45% or greater but 85% or less, and the environmental fluctuation rate X is represented by:

Environmental fluctuation rate X=(Q1−Q2)/{(Q1+Q2)/2}

where Q1 is a quantity of electric charge of the toner in an environment having a temperature of 10 degrees Celsius and relative humidity of 15%, Q2 is a quantity of electric charge of the toner in an environment having a temperature of 27 degrees Celsius and relative humidity of 80%, and a unit for Q1 and Q2 is μC/g.

### TECHNICAL FIELD

The present disclosure relates to an image forming apparatus.

### BACKGROUND ART

In an image forming apparatus equipped with a fixing device serving as a heating device, as operation of fixing, the fixing device heats and presses an image formed on a recording medium. As a result of the operation of fixing, the image is fixed on the recording medium.

In an image heating device disclosed in PTL 1 (Japanese Unexamined Patent Application Publication No. 2020-67477), for example, an image is fixed on a sheet by pressing and heating the sheet at a nip between an endless fixing belt and a press roller.

### CITATION LIST

### Patent Literature

[PTL 1]
Japanese Unexamined Patent Application Publication No. 2020-67477

### SUMMARY OF INVENTION

### Technical Problem

The present disclosure has an object to provide an image forming apparatus that prevents uneven gloss of an image formed on a recording medium.

### Solution to Problem

According to an aspect of the present disclosure, an image forming apparatus includes a toner, and a fixing device configured to fix an image formed with the toner on a recording medium. The fixing device includes a fixing belt that is an endless belt, and a planar member configured to heat the fixing belt. An environmental fluctuation rate X is 45% or greater but 85% or less, and the environmental fluctuation rate X is represented by:

Environmental fluctuation rate X=(Q1−Q2)/{(Q1+Q2)/2}

where Q1 is a quantity of electric charge of the toner in an environment having a temperature of 10 degrees Celsius and relative humidity of 15%, Q2 is a quantity of electric charge of the toner in an environment having a temperature of 27 degrees Celsius and relative humidity of 80%, and a unit for Q1 and Q2 is μC/g.

### Advantageous Effects of Invention

The present disclosure can provide an image forming apparatus that prevents uneven gloss of an image formed on a recording medium.

### BRIEF DESCRIPTION OF DRAWINGS

FIG. 1 is a schematic view illustrating an example of an image forming apparatus.

FIG. 2 is a schematic view illustrating an example of a fixing device.

FIG. 3 is a perspective view illustrating an example of the fixing device.

FIG. 4 is an exploded perspective view illustrating an example of the fixing device.

FIG. 5 is a perspective view illustrating an example of a heating device.

FIG. 6 is an exploded perspective view illustrating an example of the heating device.

FIG. 7 is a plan view illustrating an example of a heater.

FIG. 8 is a view illustrating an example of electricity supply to the heater.

FIG. 9 is a view illustrating an example of a blow-off device.

FIG. 10A is a plan view illustrating an example of the heater of another embodiment.

FIG. 10B is a side view illustrating the example of the heater of another embodiment.

FIG. 11 is an exploded perspective view illustrating an example of the heater.

FIG. 12 is a perspective view illustrating an example of a state that a connector is connected to the heater.

FIG. 13A is a plan view illustrating an example of the heater of yet another embodiment.

FIG. 13B is a plane view illustrating the example of the heater of yet another embodiment.

FIG. 13C is a plane view illustrating the example of the heater of yet another embodiment.

FIG. 14 is a plan view illustrating an example of the heater of yet another embodiment, which is different from the embodiment of FIGS. 13A to 13C.

FIG. 15 is a view illustrating an example of a fixing device equipped with a soaking plate.

FIG. 16 is a view illustrating an example of a fixing device equipped with a soaking plate that is different from the soaking plate of FIG. 15.

FIG. 17 is a view illustrating an example of a fixing device equipped with a soaking plate that is different from the soaking plates of FIGS. 15 and 16.

FIG. 18 is a view illustrating an example of a positional relationship of longitudinal directions of the heater, the soaking plate, and the image forming region.

FIG. 19 is a perspective view illustrating an example of a developing roller and an edge seal.

FIG. 20 is a perspective view illustrating an example of the edge seal.

FIG. 21 is a view illustrating an example of a divided region in the heater of FIG. 13A.

FIG. 22 is a view illustrating an example of a divided region in the heater of FIG. 13B.

FIG. 23 is a view illustrating an example of a divided region in the heater of FIG. 13C.

FIG. 24 is a schematic view illustrating an example of a structure of another fixing device.

FIG. 25 is a schematic view illustrating an example of a structure of another fixing device.

FIG. 26 is a schematic view illustrating an example of yet another fixing device.

### DESCRIPTION OF EMBODIMENTS

Embodiments of the present disclosure will be described with reference to drawings hereinafter. In the drawings, the identical parts are indicated with the identical numerical reference, and duplicated description may be appropriately simplified or eliminated.

<Description of Image Forming Apparatus>

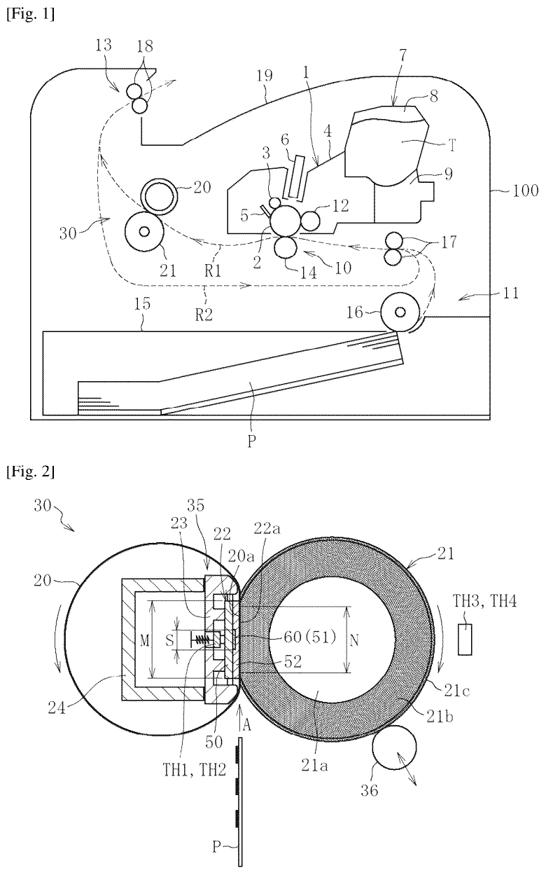

FIG. 1 is a schematic view illustrating an embodiment of the image forming apparatus of the present disclosure. First, the entire structure and operation of the image forming apparatus will be described with reference to FIG. 1.

The image forming apparatus illustrated in FIG. 1 is a monochromic image forming apparatus. In the main body of the apparatus (i.e., an image forming apparatus main body) 100, a process unit 1 is detachably mounted as an image formation unit. The process unit 1 includes a photoconductor 2 serving as an image bearer, a charging roller 3 serving as a charging unit, a developing device 4 serving as a developing unit, and a cleaning blade 5 serving as a cleaning unit. Moreover, a LED hear array 6 serving as an exposing unit is arranged to face the photoconductor 2. The photoconductor 2 bears an image on a surface thereof. The charging roller 3 is configured to charge the surface of the photoconductor 2. The developing device 4 is configured to turn a latent image on the photoconductor 2 into a visible image. The cleaning blade is configured to clean the surface of the photoconductor 2. The LED head array 6 is configured to expose the surface of the photoconductor 2 to light. The developing device 4 includes a developing roller 12 serving as a developer bearer. The developing roller 12 is configured to supply a developer born on the surface thereon to the photoconductor to turn the latent image on the photoconductor 2 into a visible image.

In the process unit 1, a toner cartridge 7 serving as a powder storage container is detachably mounted. The toner cartridge 7 is configured to store therein a toner, which is powder for image formation. The toner cartridge 7 includes a fresh toner storage unit 8 and a recycled toner storage unit 9. The fresh toner storage unit 8 is configured to store therein a fresh toner T. The recycled toner storage unit 9 is configured to store therein a recycled toner, which has been used and recovered.

Moreover, the image forming apparatus includes a transferring device 10, a paper feeding device 11, a fixing device 30, a paper ejection device 13, and a pair of registration roller 17 serving as timing rollers. The transferring device 10 is configured to transfer the image onto a sheet serving as a recording medium. The paper feeding device 11 is configured to supply a sheet. The fixing device 30 is configured to fix the image, which has been transferred onto the sheet, on the surface of the sheet. The paper ejection device 13 is configured to discharge the sheet from the apparatus.

The transferring device 10 includes a transfer roller 14 serving as a transfer member. The transfer roller 14 is disposed to be in contact with the photoconductor 2 in the state that the process unit 1 is mounted in the apparatus main body 100. Moreover, the transfer roller 14 is connected to a power source, and the predetermined direct current (DC) voltage and/or alternate current (AC) voltage is applied from the power source to the transfer roller 14.

The paper feeding device 11 includes a paper feeding cassette 15, and a paper feeding roller 16. Sheets P are stored in the paper feeding cassette 15. The paper feeding roller 16 is configured to feed a sheet P stored in the paper feeding cassette 15 towards the downstream of the sheet conveyance direction.

The fixing device 30 includes a fixing belt 20 serving as a fixing member, and a press roller 21 serving as a press member. The fixing belt 20 is configured to fix the image on the sheet. The press roller 21 is disposed to face the fixing belt 20. The fixing belt 20 is heated by a heating unit, such as a heater. The press roller 21 is configured to press towards the fixing belt 20, and is brought into contact with the fixing belt 20 to form a fixing nip.

The paper ejection device 13 includes a pair of paper ejection rollers 18 configured to eject the sheet from the apparatus. Moreover, a paper ejection tray 19, on which the sheets ejected by the paper ejection rollers 18 are stacked, is formed on the top surface of the exterior of the apparatus main body 100.

Inside the apparatus main body 100, moreover, a conveying path R1 is arranged, where the conveying path R1 is for conveying the sheet P from the paper feeding cassette 15 to the paper ejection roller 18 via the registration rollers 17, the image transfer section (transfer nip) formed between the transfer roller 14 and the photoconductor 2, and the fixing device. Inside the image forming apparatus 100, furthermore, a double-side conveying path R2 is arranged. The double-side conveying path R2 is a conveying path for conveying the sheet P, which has passed through the fixing device 30, back to the image transfer section when printing is performed on both sides of the sheet.

Subsequently, image formation operation of the image forming apparatus of the present embodiment will be described with reference to FIG. 1. Once the image formation operation is started inside the image forming apparatus 100, the photoconductor 2 is driven to rotate, and a surface of the photoconductor 2 is uniformly charged with the predetermined polarity by the charging roller 3. Then, the charged surface of the photoconductor 2 is exposed to light emitted from the LED hard array 6 based on the image information sent from a scanner or a computer, to thereby form an electrostatic latent image on the surface of the photoconductor 2. The developing device 4 supplies a toner to the electrostatic latent image on the photoconductor 2 to develop (visualize) the electrostatic latent image to form a toner image.

Once the image formation operation is started, moreover, the paper feeding rollers 16 are driven to rotate, and a sheet P is fed from the paper feeding cassette 15. The fed sheet P is temporality stopped at the registration rollers 17. Thereafter, the registration rollers 17 are driven to rotate at the predetermined timing, to transport the sheet P to the image transfer section synchronizing with the timing when the toner image on the photoconductor 2 reaches the image transfer section.

When the sheet P is transported to the image transfer section, the toner image on the photoconductor is transferred onto the sheet P by transfer electric field. The transfer electric field is generated by applying the predetermined voltage to the transfer roller 14. The toner on the photoconductor 2, which has not been transferred to the sheet P, is removed by the cleaning blade 5 and collected to the recycled toner storage unit 9 of the toner cartridge 7.

The sheet P on which the toner image has been transferred is transported to the fixing device 30. As the sheet P passes through the fixing nip formed between the fixing belt 20 and the press roller 21, the sheet P is heated and pressed to thereby fix the toner image on the surface of the sheet P. The sheet P is discharged from the apparatus by the paper ejection rollers 18 to stack on the paper ejection tray 19.

When printing is performed on both sides of a sheet, the sheet P passed through the fixing device 30 is send back to the both side conveying path R2 without being discharged from the apparatus. The sheet P is passed through the both side conveying path to be fed into the conveying path R1 just before the registration rollers 17, and the sheet P is again transported to the image transfer section by the registration rollers 17. Then, an image is transferred to the back side of the sheet P, and the image on the back side is fixed on the back surface of the sheet by the fixing device 30. Thereafter, the sheet P is discharged from the apparatus.

<Description of Fixing Device>

Subsequently, the detailed structure of the fixing device 30 will be described.

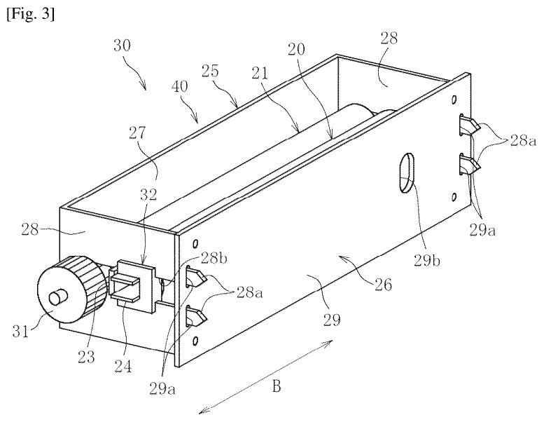

As illustrated in FIG. 2, the fixing device 30 of the present embodiment includes a fixing belt 20 serving as a fixing member or a belt member, a press roller 21 serving as a counter member or a press member, and a heating device 35. Moreover, the heating device 35 includes a planar heater 22 serving as a planar member, a heat holder 23 serving as a holding member, a stay 24 serving as a supporting member, a soaking roller 36 serving as a highly heat conductive member, and first to fourth thermistors TH1-TH4 serving as temperature sensor members. The press roller 21 comes in contact with the circumferential surface of an endless belt of the fixing belt 20 to form a fixing nip N. The heating device 35 is configured to heat the fixing belt 20. The heat holder 23 is configured to hold the heater 22. The stay 24 is configured to support the heat holder 23. The fixing belt 20, press roller 21, heater 22, heat holder 23, stay 24, and soaking roller 36 are extended along the direction orthogonal to the paper surface in FIG. 2 (see the direction indicated with the double arrow B of FIG. 3). The direction as mentioned may be referred to as a longitudinal direction of each member (with proviso that the direction is also the axial direction of the press roller 21), or longitudinal direction of the heating device 35 or the fixing device 30 hereinafter. Moreover, the longitudinal direction is also a width direction of a sheet passed through the fixing device 30. However, the longitudinal direction of the heater 22 is not necessarily matched with the longitudinal direction of other members or devices.

The fixing belt 20 is an endless belt member. The fixing belt 20 has, for example, a cylindrical base that is polyimide (PI) having an outer diameter of 25 mm and a thickness of from 40 micrometers through 120 micrometers. In order to enhance durability and secure releasability, a release layer (surface layer) is formed as the outermost layer of the fixing belt 20. The release layer includes a fluororesin, such as PFA and PTFE, and has a thickness of from 5 micrometers through 50 micrometers. An adhesive layer is disposed between the release layer (surface layer) and the base to bond the release layer and the base together. In the present embodiment, particularly, only the adhesive layer is disposed between the release layer and the base, and an elastic layer is not disposed. Therefore, the rigidity of the fixing belt 20 can be made low, and variations in the width of the inner surface nip M along the sheet conveyance direction can be reduced. Since a total thickness of all the layers of the fixing belt 20 is set to the range of from 50 micrometers through 100 micrometers, moreover, the fixing belt 20 can achieve both strength and flexibility. Therefore, the fixing belt 20 of the present embodiment is preferable.

The base of the fixing belt 20 is not limited to polyimide. The base of the fixing belt 20 may include a heat resistant resin, such as PEEK, or may be a metal base, such as nickel (Ni) and SUS. The inner circumferential surface of the endless belt of the fixing belt 20 may be coated with polyimide or PTFE as a sliding layer. However, the base of the fixing belt 20 preferably includes a resin material because the rigidity of the fixing belt 20 is made low to secure a width of the inner surface nip M along the sheet conveyance direction A (i.e., the width along the up-down direction in FIG. 2, also the width along the direction perpendicular to the longitudinal direction or the width of the below-described heater 22 along the shorter side of the base 50). The inner surface nip M is a section where the inner circumference surface of the fixing belt 20 is brought into contact with the heater 22. When the rigidity of the base of the fixing belt 20 is excessively high, the fixing belt 20 is not easily deformed towards the inner side by pressure applied from the press roller 21. As a result, the inner circumferential surface of the endless belt of the fixing belt 20 does not easily come into contact with the heater 22, and therefore variations in the width of the inner surface nip M along the sheet conveyance direction across the longitudinal direction increase. Since the base of the fixing belt 20 includes a resin material in the present embodiment, the inner surface nip M is widened to make the nip have the width substantially the same as the width of the fixing nip N. Therefore, variations in the width of the inner surface nip M along the sheet conveyance direction across the longitudinal direction can be reduced. As a result, uneven gloss of an image fixed can be prevented. The fixing belt 20 of the present embodiment is more preferable, particularly because the flexibility, strength, and heat resistance of the base can be secured by forming the base of the fixing belt 20 with polyimide in the present embodiment.

Moreover, an elastic layer including robber etc. and having a thickness of from 50 micrometers from 500 micrometers may be disposed between the base and a release layer (i.e., the surface layer). When the fixing belt 20 does not include an elastic layer, the rigidity of the fixing belt 20 can be kept low. As a result, variations in the width of the inner surface nip M along the sheet conveyance direction across the longitudinal direction can be reduced. Therefore, uneven gloss of an image fixed on a sheet can be prevented.

Moreover, the thermal conductivity of the base of the fixing belt 20 is preferably set to the range of from 0.6 W/mK through 2.0 W/mK. When the thermal conductivity of the base of the fixing belt 20 is 0.6 W/mK or greater, heat is easily transmitted through the fixing belt 20 to minimize unevenness in the temperature of the fixing belt 20. In the present embodiment, the above-mentioned thermal conductivity can be achieved by adding thermal conductive filler to the material of the base of the fixing belt 20, which is polyimide. The abrasion resistance or buckling strength of the fixing belt 20 can be attained by adjusting the amount of the filler to adjust the thermal conductivity of the base of the fixing belt to the range of 2.0 W/mK or less. The thermal conductivity of the base of the fixing belt 20 is more preferably set to the range of from 0.8 W/mK through 1.3 W/mK. As a result, both an effect of reducing unevenness in the temperature of the fixing belt 20 and the abrasion resistance or buckling strength of the fixing belt 20 can be achieved.

Next, the calculation method of the thermal conductivity will be described. When the thermal conductivity is calculated, the thermal diffusivity of the target object is measured, and the thermal conductivity is calculated using the thermal diffusivity.

<Measuring Method of Thermal Diffusivity>

The measurement of the thermal diffusivity is performed by a thermal diffusivity-thermal conductivity measuring device (product name: ai-Phase Mobile 1u, available from ai-Phase Co., Ltd.).

<Calculation of Thermal Conductivity>

The values of density and specific heat capacity are used to convert the thermal diffusivity into thermal conductivity. The density is measured by means of a dry automatic pycnometer (product name: Accupyc 1330, available from Shimadzu Corporation). Moreover, the specific heat capacity is measured by means of a differential scanning calorimeter (product name: DSC-60, available from Shimadzu Corporation) using sapphire as a standard material the specific heat capacity of which is already known. In this embodiment, the measurement of the specific heat capacity is performed 5 times, and the average value of the obtained measurement values at 50 degrees Celsius is used. The thermal conductivity X can be determined by the following formula (1) where p is the density, C is the specific heat capacity, and a is the thermal diffusivity determined by the above-described measurement of the thermal diffusivity.

[Math. 1]

λ=ρ×C×α (1)

For example, the press roller 21 has the outer diameter of 25 mm. The press roller 21 includes a cored bar 21a, an elastic layer 21b, and a release layer 21c. The cored bar 21a is a part formed of solid iron. The elastic layer 21b is formed on the surface of the cored bar 21a. The release layer 21c is formed at the outer side of the elastic layer 21b. The elastic layer 21b is formed of silicone rubber, and a thickness thereof is, for example, 3.5 mm. In order to enhance releasability, the release layer 21c that is, for example, a fluororesin layer having a thickness of about 40 micrometers is ideally formed on the surface of the elastic layer 21b.

The fixing belt 20 is pressed to the side of the press roller 21 by a press system, and is pressed against the press roller 21. As a result, a fixing nip N is formed between the fixing belt 20 and the press roller 21. Moreover, the press roller 21 receives a driving force from a driving unit disposed in the image forming apparatus main body to be driven to rotate, and functions as a driving roller. Meanwhile, the fixing belt 20 is designed to be driven to rotate by the rotations of the press roller 21.

As the fixing belt 20 is rotated, the fixing belt 20 slides against the 22. In order to enhance sliding property of the fixing belt 20, therefore, a lubricant, such as oil and grease, may be provided between the heater 22 and the fixing belt 20. It is preferred that the surface roughness of the inner circumferential side of the fixing belt 20 be greater than the surface roughness of the sliding surface 20a. As a result, the lubricant is held in recesses of the sliding surface 20a of the fixing belt 20, and the lubricant is stably taken into the inner surface nip M along the rotations of the fixing belt 20. Therefore, unevenness in the thickness of the lubricant along the longitudinal direction at the inner surface nip M can be suppressed, and unevenness in transmittance of heat from the heater 22 to the fixing belt 20 can be suppressed. As a result, the temperature variations across the longitudinal direction of the heater 22 can be suppressed. For example, the surface roughness can be determined by arithmetic average roughness (Ra) as specified in JIS B0601-2001. The arithmetic average roughness (Ra) can be measured by the method according to JIS B0601-2001 by means of a surface roughness measuring instrument SURFCOM 1400A (available from TOKYO SEIMITSU CO., LTD.) with the evaluation length (Ln) of 1.5 mm, the standard length (L) of 0.25 mm, and the cut-off value of 0.8 mm.

Moreover, the skewness of the roughness curve of the sliding surface 20a of the fixing belt 20 along the sliding direction may be set to be greater than the skewness of the roughness curve of the sliding surface 22a of the heater 22 along the sliding direction. As a result, variations in the thickness of the lubricant along the inner surface nip across the longitudinal direction can be reduced, and uneven distribution of heat from the heater 22 to the fixing belt 20 can be prevented. As a result, variations in temperature of the heater 22 across the longitudinal direction can be reduced. The skewness (Rsk) of the roughness curve is one of indexes of surface roughness specified in 4.2.3 of JIS B0601-2013, and indicates the degree of symmetry between a peak and a valley when the average line is determined as a center. The skewness (Rsk) of the roughness curve is represented by a cubic mean value of z(x) of the standard length that is nondimensionalized with a cubic value of the root mean square roughness (Rq) of the profile, as in the following formula (2).

$$\begin{matrix}[ Math . 2 ] & \\ Rsk = \frac{1}{R {q}^{3}} [ \frac{1}{ℓ} {\int }_{0}^{ℓ} {z}^{3} ( x ) dx ] & ( 2 )\end{matrix}$$

The heater 22 is disposed across the longitudinal direction. The heater 22 comes into contact with the inner circumferential surface of the fixing belt 20 at the position where the fixing belt 20 is to be in contact with corresponding to the press roller 21 across the longitudinal direction. The heater 22 is configured to heat the fixing belt 20 serving as a heated member, and the heater 22 is a member configured to heat the fixing belt 20 to the predetermined fixing temperature.

The heater 22 includes a base 50, a conductor layer 51, and an insulating layer 52 disposed in this order from the opposite side to the side where the inner circumferential surface of the fixing belt 20 is present. The conductor layer 51 is a conductor, such as a heating unit 60 disposed on a surface of the base 50. The insulating layer 52 convers the surface of the base 50 and a surface of the conductor layer 51, and is present between the inner circumferential surface of the fixing belt 20, and the base 50 and conductor layer 51.

As the base 50, a metal material (e.g., stainless steel (SUS), iron, and aluminium), ceramic, or glass may be used. The material of the base 50 is particularly preferably ceramic (e.g., alumina, and aluminium titanate), glass, or mica is particularly preferable considering excellent heat resistance and insulation properties thereof. Since an insulating material, such as ceramic, is used for the base 50 in the present embodiment, an insulating layer is not disposed between the base 50 and the conductor layer 51. Moreover, an embodiment of the base 50 may be a structure where an insulating layer is disposed on the base 50 formed of a metal. In this case, the material of the base 50 is preferably aluminium or stainless steel considering cost efficiency. Moreover, the material of the base 50 is preferably copper, graphite, or graphene considering excellent thermal conductivity and uniformity of a temperature of the heater 22.

A material of the insulating layer 52 may be a material having insulation, such as heat resistant glass. Moreover, the material may include ceramic or polyimide (PI).

Unlike the present embodiment, the heating unit 60 may be arranged at the opposite side to the side of the fixing belt 20 (i.e., at the side of the heater holder 23) from the base 50. In this case, heat of the heating unit is transmitted to the fixing belt 20 via the base 50, and therefore the material of the base 50 is ideally a material having high thermal conductivity, such as aluminium nitrate.

The heater 22 may have no contact with, or may be indirectly in contact with the fixing belt 20 via a low friction sheet. In order to enhance the heat transfer efficiency of the heater 22 to the fixing belt 20, preferable is a structure where the heater 22 is directly brought into contact with the inner circumferential surface of the fixing belt 20 as in the present embodiment. Moreover, the heater 22 may be arranged to be in contact with the outer circumferential surface of the fixing belt 20. In this case, however, fixing quality may be deteriorated once the outer circumferential surface of the fixing belt 20 is damaged as a result of contact with the heater 22. Therefore, the heater 22 is preferably in contact with the inner circumferential surface of the fixing belt 20.

The heater holder 23 and the stay 24 are arranged at the inner side of the endless belt of the fixing belt 20. The stay 24 may be a metal channel both ends of which are supported by the both wall surfaces of the fixing device 30. Since the stay 24 supports the surface of the heater holder 23 at the side opposite to where the heater 22 is disposed, the heater 22 and the heater holder 23 are not significantly bent by the pressure applied by the press roller 21, and the shapes thereof can be maintained. As a result, a fixing nip N is formed between the fixing belt 20 and the press roller 21 as a nip.

The heater holder 23 tends to be heated to a high temperature by the heat from the heater 22. Therefore, a material of the heater holder 23 is ideally a heat resistant material. For example, the material of the heater holder 23 is a heat resistant resin of low thermal conductivity, such as LCP, so that thermal conduction from the heater 22 to the heater holder 23 is suppressed and the heater 22 can efficiently heat the fixing belt 20.

The soaking roller 36 is a roll member extending along the longitudinal direction. The soaking roller 36 is brought into contact with the outer circumferential surface of the press roller 21 across the longitudinal direction. The soaking roller 36 is rotatable disposed with setting the longitudinal direction as an axial direction. Since the soaking roller 36 is in contact with the outer circumferential surface of the press roller 21, uneven distribution of the temperature of the press roller 21 and the fixing belt 20 in contact with the press roller 21 across the longitudinal direction can be prevented. The soaking roller 36 include a material having high thermal conductivity, such as aluminium and copper, disposed along the longitudinal direction.

The soaking roller 36 may be arranged to be in contact with the press roller 21 and driven to rotate by the rotation of the press roller 21, or may be arranged and driven to rotate by the driving force transmitted from a driving source.

The soaking roller 36 is brought into contact with and separated from the press roller 21 by a contact-separation mechanism. It is preferred that the soaking roller 36 be brought into contact with the press roller 21 when the distribution of heat in the press roller 21 or fixing belt 20 is desired. As a result, the soaking roller 36 is not in contact with the press roller 21 and the heat is not taken away by the soaking roller 36 unnecessarily, when the distribution of the heat is not desired. The timing for bringing the soaking roller 36 into contact with the press roller 21 is determined based on detection results from the thermistors TH1 to TH4.

The soaking roller 36 may be arranged to be in contact with a surface of the fixing belt 20. In this case, a surface of the soaking roller 36 is coated with a material having high lubricity, such as PTFE and PTA, to prevent adhesion of a toner on the surface of the soaking roller 36.

The first thermistor TH1 and second thermistor TH2 are disposed in the position at the back surface of the base 50 and facing the heating unit 60. The third thermistor TH3 and fourth thermistor TH4 are disposed to face the outer circumferential surface of the press roller 21. Since the press roller 21 has a large heat capacity and heat is transmitted via the fixing belt 20, the temperature of the press roller 21 is relatively low. Accordingly, inexpensive thermistors may be used as the third thermistor TH3 and fourth thermistor TH4 configured to detect the temperature of the press roller 21. If all of the thermistors are arranged inside the endless belt of the fixing belt 20, a diameter of the endless belt of the fixing belt 20 becomes large in order to secure an area for accommodating lead wires extending from the thermistors. In the present embodiment, however, the third thermistor TH3 and fourth thermistor TH4 are disposed outside the endless belt of the fixing belt 20 to allow the endless belt of the fixing belt 20 to have a small diameter.

Once printing operation starts, electricity is supplied to the heater 22, and the heating unit 60 generates heat. The heat generated by the heating unit 60 heats the fixing belt 20. Moreover, the press roller 21 is driven to rotate, and the fixing belt 20 is rotated by the rotation of the press roller 21. In the state where the temperature of the fixing belt 20 reaches the predetermined target temperature (i.e., the fixing temperature), as illustrated in FIG. 2, the sheet P carrying an unfixed toner image is transported into the gap between the fixing belt 20 and the press roller 21 (i.e., the fixing nip N) (see the direction indicated with the arrow A in FIG. 2). As a result, the unfixed toner image is heated and pressed to be fixed on the surface of the sheet P.

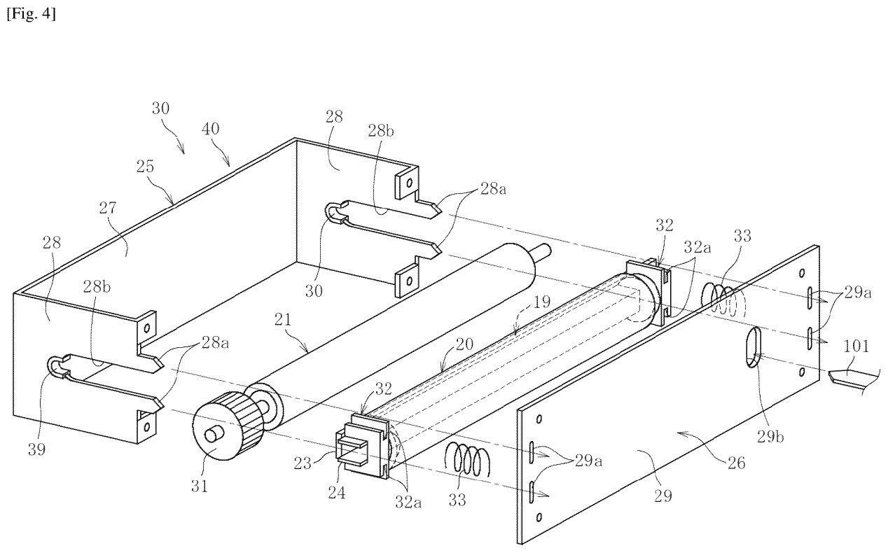

FIG. 3 is a perspective view illustrating an example of the fixing device, and FIG. 4 is an exploded perspective view of FIG. 3.

As illustrated in FIGS. 3 and 4, the device frame 40 of the fixing device 30 includes a first device frame 25, and a second device frame 26. The first device frame 25 includes a pair of side walls 28, and a front wall 27. The second device frame 26 include a rear wall 29. A pair of the side walls are disposed one end and the other end, respectively, relative to the longitudinal direction. The both side walls support the both ends of the fixing belt 20, press roller 21, and heating device 35. Each wide wall 28 has a plurality of engagement protrusions 28a. Each engagement protrusion 28a is engaged with an engagement hole 29a provided in the rear wall 29 to assemble the first device frame 25 and the second device frame 26 together.

Moreover, each side wall 28 has an insertion notch 28b through which a rotation axis of the press roller 21 etc. is inserted. The insertion notch 28b has an open end at the side of the rear wall 29, and the closed end of the insertion notch 28b at the opposite side is an abutment. A bearing 39 configured to support the rotation axis of the press roller 21 is disposed at the side of the end of the side wall 28 where the abutment is provided. The both ends of the rotation axis of the press roller 21 are mounted in the bearings 39 respectively so that the press roller 21 is rotatable supported by the both side walls 28.

Moreover, a driving force transmission gear 31 serving as a driving force transmission member is disposed at one end of the rotation axis of the press roller 21. The driving force transmission gear 31 is disposed to be exposed to the outside of the side wall 28 in the state where the press roller 21 is supported by the both side walls 28. When the fixing device is mounted in a main body of an image forming apparatus, therefore, the driving force transmission gear 31 is coupled with a gear mounted in the main body of the image forming apparatus, to thereby transmit driving force from a driving power source to the press roller 21. The driving force transmission member configured to transmit the driving force to the press roller 21 may be pulleys around which a driving force transmission belt is suspended, or a coupling system, as well as the driving force transmission gear 31.

At the both ends of the heading device 35 relative to the longitudinal direction, a pair of flanges 32 configured to support the fixing belt 20, the heater holder 23, and the stay 24 are disposed. Each flange 32 has a guide groove 32a. The guide groove 32a is inserted along the rim of the insertion notch 28b of the side wall 28 to assemble the flange 32 with the side wall 28.

Moreover, a pair of springs 33 serving as bias members are pressed against to the flanges 32, respectively. Since the stay 24 or the flange 32 is biased by the spring 33 to the side of the press roller 21, the fixing belt is pressed against the press roller 21 to form a fixing nip between the fixing belt 20 and the press roller 21.

As illustrated in FIG. 4, moreover, a hole 29b serving as a positioning unit is provided at one end of the rear wall constituting the second device frame 26 relative to the longitudinal direction, as illustrated in FIG. 4. The hole 29b is used to position the fixing device main body in the main body of the image forming apparatus. In the main body of the image forming apparatus, meanwhile, a protrusion 101 serving a positioning unit is disposed. The protrusion 101 is inserted into the hole 29b of the fixing device to fit the protrusion 101 and the hole 29b together. As a result, the positioning of the main body of the fixing device in the longitudinal direction is performed in the main body of the image forming apparatus. At the end of the rear wall 29 opposite to the end thereof where the hole 29b is disposed, a positioning unit is not disposed. As a result, the main body of the fixing device are freely expanded and contracted in the longitudinal direction due to temperature change without restrictions.

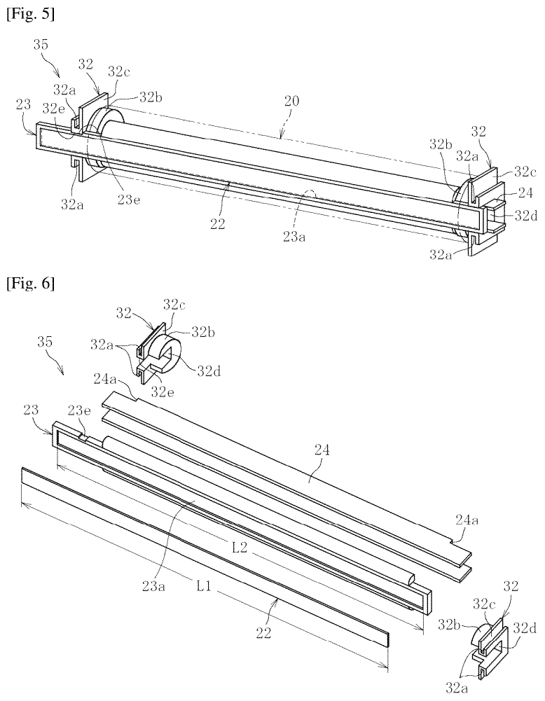

FIG. 5 is a perspective view illustrating the heating device 35, and FIG. 6 is an exploded perspective view of FIG. 5.

As illustrated in FIGS. 5 and 6, a rectangular accommodating recess 23a configured to accommodate the heater 22 is disposed on the surface of the heating holder 23 at the fixing belt side (the front surface in FIGS. 5 and 6). The accommodating recess 23a is formed into the shape and size substantially same as the shape and size of the heater 22. The size L2 of the accommodating recess 23a in the longitudinal direction is set to be slightly longer than the size L1 of the heater 22 in the longitudinal direction, and therefore the heater 22 and the accommodating recess 23a do not interfere with each other even when the heater 22 is expanded in the longitudinal direction thereof due to thermal expansion. Moreover, the heater 22 together with the below-described connector serving as a power supply member are held with the heater holder 23 in the state where the heater 22 is accommodated inside the accommodating recess 23a.

A pair of the flanges 32 each have a belt supporting unit 32b, a belt regulating unit 32c, and a support recess 32d. The belt supporting unit 32b is a C-shaped unit that is inserted into the inner side of the endless belt of the fixing belt 20 to support the fixing belt 20. The belt regulating unit 32c is a flange unit that is brought into contact with the edge of the fixing belt 20 to regulate the movement (offset) thereof in the longitudinal direction. The support recess 32d is a section into which both ends of the heater holder 23 and stay 24 are inserted to support the heater holder 23 and the stay 24. Since the belt supporting units 23b are inserted at the both ends of the fixing belt 20, the fixing belt 20 is supported in the free belt system. The free belt system is a system where the fixing belt 20 is supported basically without tension in the circumferential direction of the fixing belt (i.e., the belt rotating direction) when the belt is not rotated.

As illustrated in FIGS. 5 and 6, a positioning recess 23e is disposed at one end of the heater holder 23 relative to the longitudinal direction. The fitting unit 323 of the left flange 32 in FIGS. 5 and 6 is fitted with the positioning recess 23e to perform positioning of the heater holder 23 and the flange 32 in the longitudinal direction. Meanwhile, the right flange 32 in FIGS. 5 and 6 does not have a fitting unit 32e, and positioning of the flange 32 with the heater holder 23 in the longitudinal direction is not performed. Since the positioning of the heater holder 23 with the flange 32 in the longitudinal direction is performed only at the one side thereof, the heater holder 23 is freely expanded and contracted even when the heater holder 23 is expanded and contracted in the longitudinal direction due to the temperature change.

As illustrated in FIG. 6, moreover, steps 24a configured to regulate the movement of the stay 24 against the flanges 32 are disposed at the both ends of the stay 24 in the longitudinal direction. The flange 32 is allowed to abut on each step 24a so that the movement of the stay 24 in the longitudinal direction relative to the flange 32 is regulated. At least one of the steps 24a is disposed to leave a gap (end play) with the flange 32. Since at least one of the steps 24a is disposed to leave a gap with the flange 32, the stay 24 is freely expanded and contracted without restrictions, even when the stay 24 is expanded and contracted in the longitudinal direction due to the temperature change.

Next, the specific structure of the heater 22 will be described.

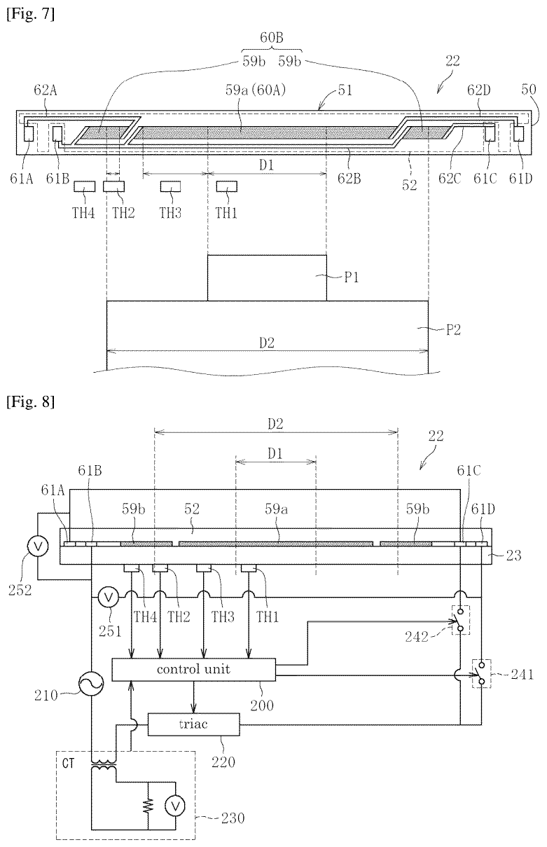

As illustrated in FIG. 7, the conductor layer 51 includes resistance heating elements 59a and 59b (59), the first to fourth electrode units 61A to 61D (61), and the first to fourth power supply lines 62A to 62D (62) as conductors.

The resistance heating element 59 is a main heating part of the heater 22. For example, the resistance heating element 59 can be formed by applying a paste, which has been prepared with silver palladium (AgPd) or glass powder, onto the base 40 by screen printing etc., followed by firing the base 50.

Other than the examples mentioned above, a resistance material, such as silver alloy (AgPt) and ruthenium oxide (RuO₂), may be used as the material of the resistance heating element 59. In the present embodiment, the resistance value of the resistance heating element 59 is set to 80Ω at room temperature.

As illustrated in FIG. 2, the width of the fixing nip N along the sheet conveyance direction (i.e., the up-down direction width in FIG. 2) is greater than the width S of the resistance heating element 59 along the sheet conveyance direction (i.e., the shorter direction of the base 50). Even when the width of the fixing nip N varies across the longitudinal direction, therefore, the fixing nip N can be formed in the range of the width S. As a result, the heat generated by the resistance heating element 59 is properly transferred to the fixing belt 20. The above-described effect can be obtained by making the width of the fixing nip N along the conveyance direction greater than the width S at least an arbitrary position across the longitudinal direction. Moreover, the width of the fixing nip N along the sheet conveyance direction is preferably greater than the width S in the entire region across the longitudinal direction of the fixing nip N, because uneven distribution of heat particularly from the resistance heating element 59 to the fixing belt 20 can be prevented and therefore the fixing belt 20 can be efficiently heated.

The width S of the resistance heating element 59 is measured with a caliper etc. by observing the heater 22 via the insulating layer. When the resistance heating element 59 is visually blocked by the insulating layer and cannot be observed, the heater 22 is cut along the direction perpendicular to the longitudinal direction, and the obtained cross-section may be observed under a microscope to measure the width S. Moreover, the width of the fixing nip N can be measured in the following manner. For example, the fixing belt 20 is rotated in the state where the surface of the fixing belt 20 is controlled to the predetermined temperature (e.g., 160 degrees Celsius), and an image is printed on a transparent plastic sheet (e.g., a sheet for overhead projectors (OHP)), or a black solid image is printed on a sheet. In the process of the printing, the operation of the image forming apparatus is stopped for the predetermined period (e.g., 10 seconds), a width of the area of the fixing belt 20 or press roller 21, where the color thereof is changed, is measured by means of a caliper etc.

As illustrated in FIG. 7, the power supply line 62 is a conductor having a resistance value smaller than the resistance value of the resistance heating element 59. As a material of the power supply line 62 or electrode unit 61, silver (Ag) or silver palladium (AgPd) may be used. The power supply line 62 or electrode unit 61 may be formed by screen printing any of the above-listed materials.

The first heating unit 60A includes the resistance heating element 59a disposed at the center relative to the longitudinal direction. The second heating unit 60B includes two resistance heating elements 59b disposed at the both ends. The resistance heating element 59a and resistance heating elements 59b are disposed substantially horizontally to one another to align into a shape of a rectangle. As a result, the area of the gap between the resistance heating elements can be made small, and an amount of heat generated in the divided region between the resistance heating elements can be made large. Accordingly, uneven generation of heat of the heater 22 along the longitudinal direction can be prevented.

The one end of the resistance heating element 59a is electrically connected to the second electrode unit 61B via the second power supply line 62B, and the other end of the resistance heating element 59a is electrically connected to the fourth electrode unit 611D via the fourth power supply line 62D. One end of the resistance heating element 59b that is disposed at one side of the longitudinal direction (i.e., the left side in FIG. 7) is electrically connected to the first electrode unit 61A via the first power supply line 62A, and the other end of the resistance heating element 59b is electrically connected to the second electrode unit 61B via the second power supply line 62B. One end of the resistance heating element 59b that is disposed at the other side of the longitudinal direction (i.e., the right side in FIG. 7) is electrically connected to the second electrode unit 61B via the second power supply line 62B, and the other end of the resistance heating element 59b is electrically connected to the third electrode unit 61C via the third power supply line 62C.

The resistance heating element to generate heat can be switched by switching the electrode unit to which voltage is applied. Specifically, the resistance heating element 59a generates heat when voltage is applied to the second electrode unit 61B and the fourth electrode unit 61D. The resistance heating element 59b, which is disposed at one side of the longitudinal direction, generates heat when voltage is applied to the first electrode unit 61A and the second electrode unit 61B. The resistance heating element 59b, which is disposed at the other side of the longitudinal direction, generates heat when voltage is applied to the third electrode unit 61C and the fourth electrode unit 61D. When the first electrode unit 61A and the third electrode unit 61C are electrically connected in parallel externally, the resistance heating elements 59b of the both sides can generate heat at the same time. As described above, heat generation can be selected between heat generation from only the first heating unit 60A, and heat generation from the first heating unit and the second heating unit 60B.

The resistance heating element 59a disposed at the center relative to the longitudinal direction is arranged to have a width of 215 mm to match with A4 size sheets. The resistance heating element 59a at the center, and the resistance heating elements 59b at the both sides are arranged to have a width of 301 mm to match with A3 size sheets. Therefore, any excessive heating region is not formed when fixing operations are performed on A4 sheets and A3 sheets, and excessive heating at the one end of the fixing belt 20 relative to the longitudinal direction can be prevented.

Relative to the longitudinal direction, the first thermistor TH1 is disposed inside the feeding region D1 of the minimum size sheet P1 to be fed through the fixing device 30. As a result, the first thermistor TH1 can detect a temperature of the feeding region even when a sheet of any size is fed through the fixing device 30.

Relative to the longitudinal direction, the second thermistor TH2 and the third thermistor TH3 are disposed outside the feeding region D1 of the minimum width sheet P1, but inside the feeding region D2 of a sheet P2. The sheet P2 is a sheet having the minimum width among sheets that can be used by the fixing device 30 and each have a width larger than the resistance heating element 59a. Particularly in the present embodiment, the second thermistor TH2 is disposed in the position to correspond to the resistance heating element 59b, but the position correspond to the area other than the below-mentioned divided region. Moreover, the third thermistor TH3 is disposed in the area that is the inner side from the divided region of the resistance heating element 59a (i.e., the center side of the feeding region from the divided region, see the range indicated with the double arrow in FIG. 7). Since the second thermistor TH2 or the third thermistor TH3 is disposed at the position other than the position corresponding to the divided region, a temperature of an area other than the area where a temperature of the heater 22 tends to drop can be detected. As well as the arrangement described above, moreover, the third thermistor TH3 is preferably disposed outside the feeding region of the maximum width sheet among sheets each having a width smaller than the resistance heating element 59a. As a result, the third thermistor TH3 can detect a temperature of a non-feeding region, even when any of sheets having a width smaller than the resistance heating element 59a is printed. Accordingly, overheating of the non-feeding region of the area corresponding to the resistance heating element 59a can be prevented by controlling the heater 22 using the detected temperature by the third thermistor TH3.

The fourth thermistor TH4 is disposed in the position that is outside the feeding region D2 of the sheet P2, and faces the resistance heating element 59b.

FIG. 8 illustrates an example of a power supply circuit configured to supply electric power to the heater 22. The power supply circuit is typically disposed in a main body of the image forming apparatus 100, but the power supply circuit may be disposed in the fixing device 30.

The power supply circuit serving as a power controlling unit includes a control unit 200, an AC power source 210, a triac 220, a current detection unit 230, heater relays 241 and 242, and voltage detection units 251 and 252. A combination of the control unit 200 and the triac 220 form a power supply unit.

The AC power source 210, a current transformer CT of the current detection unit 230, the triac 220, and the heater relays 241 and 242 are arranged in series between the second electrode unit 61B, and the third electrode unit 61C and fourth electrode unit 61D disposed at the opposite side. A voltage detection unit 251 is disposed between on side of the second electrode unit 61B and the first electrode unit 61A. A voltage detection unit 252 is disposed between the other side of the second electrode unit 61B and the fourth electrode unit 61D disposed at the opposite side.

The temperatures detected by the thermistors TH1 to TH4 are input in the control unit 200. The control unit 200 is configured to control the temperatures of the resistance heating element 59a and the resistance heating elements 59b to reach the predetermined target temperature based on the temperature detected by the thermistor TH1. Specifically, the control unit 200 is control electric current supplied to the second electrode unit 61B, the third electrode unit 61C, and the fourth electrode unit 61D through duty cycle control using the triac 220.

Specifically, the control unit 200 is configured to perform duty cycle control to allow the triac 220 to control electric current passing through the resistance heating element 59a at the duty cycle according to the temperature difference between the current temperature detected by the thermistor TH1 and the target temperature. The electric current is 0 with the duty cycle of 0%, and the electric current is the maximum with the duty cycle of 100%. Similarly, the control unit 200 is configured to perform duty cycle control to allow the triac 220 to control electric current passing through the resistance heating elements 59b at the duty cycle according to the temperature difference between the current temperature detected by the thermistor TH2 and the target temperature. The “duty cycle” is a ratio of the energizing time of the resistance heating elements 59a and/or 59b per control cycle.

When the temperature difference between the temperature detected by the thermistor TH1 and the temperature detected by the thermistor TH3 exceeds the predetermined threshold, or when the temperature difference between the temperature detected by the thermistor TH2 and the temperature detected by the thermistor TH4 exceeds the predetermined threshold, operation for reducing temperature unevenness is performed. Specifically, as the operation for reducing temperature variations, actions, such as temporarily stopping conveyance of a sheet, temporarily reducing the conveying speed of a sheet, and pressing the soaking roller 36 against the press roller 21, are performed.

The control unit 200 may be a microcomputer including, CPU, ROM, RAM, I/O interface, etc. As a sheet is fed to the fixing nip N, heat removal (i.e., heat transfer from the fixing belt 20 etc. to the sheet) occurs. The control unit 200 can control the temperature of the fixing belt 20 to the desired temperature by controlling the electric current to be supplied considering not only the temperature detected by the thermistor TH1, but also heat removed by the feeding.

The current detection unit 230 is configured to detect the total current value passed through the resistance heating elements 59a and 59b. Specifically, the control unit 200 is configured to read the electric current value passed through the conductive layer with the voltage generated by the secondary resistance of the current transformer CT. Moreover, the voltage detection units 251 and 252 are configured to detect voltage values E of the resistance heating elements 59a and 59b, and the control unit 200 is configured to read the voltage values E. Then, the control unit 200 is configured to calculate the resistance values R (=E/I) of the resistance heating element 59a or 59b from the current value I and the voltage value E.

In the above-described image forming apparatus of the present disclosure, a fixing member of low heat capacity, such as the above-described fixing belt 20 is used to achieve high operation speed or energy saving of an image forming apparatus. However, a fixing device using such a fixing belt 20 of low heat capacity has a problem that an image fixed on a sheet has uneven gloss due to temperature unevenness of the fixing belt 20.

The heat capacity of the fixing belt 20 is represented by the following formula (3). The following “volume,” “thickness,” etc. are a volume, thickness, etc. of the fixing belt 20.

[Math. 3]

(Heat capacity)=(volume)×(specific heat)=(thickness)×(inner diameter)×(length)×(specific heat) (3)

The “length” of the formula (3) is determined with a size of a sheet that can be used by the fixing device, and “specific heat” is difficult to measure. Accordingly, the “heat capacity” of the fixing belt 20 is proportional to the “thickness” and “inner diameter” and therefore the heat capacity can be reduced by reducing the thickness and inner diameter of the fixing belt 20. As described above, the fixing belt 20 having the “thickness” of from 50 through 100 micrometers is preferable because both strength and flexibility of the fixing belt 20 can be achieved. Moreover, the “inner diameter” of the fixing belt 20 is preferably set to the range of from 15 mm through 40 mm. As a result, as well as achieving low heat capacity of the fixing belt 20, inner parts of the fixing device 30, such as the heater 22, can be easily laid out, and the strength of the fixing belt 20 can be maintained with preventing damages.

Considering prevention of the above-described unevenness of gloss, moreover, the greater thickness of the heater 22 is more preferable because variations in a temperature due to heat conduction within the heater 22 is unlikely to be caused. When the thickness of the heater 22 is too thick, on the other hand, the startup time of the fixing device becomes too long. Considering the above-described balance, the thickness of the heater is preferably from 0.5 mm through 2.0 mm. Moreover, the thickness of the heater 22 is more preferably from 0.6 mm through 1.2 mm.

The present inventors have found that the above-described problem of uneven gloss can be solved by heating a toner with a planar heater, such as the heater 22 (e.g., heating via the fixing belt 20) where an environmental fluctuation rate of a quantity of electric charge of the toner is within the predetermined range. Accordingly, the temperature of the toner is determined by the following formula (4), and the “temperature rise value of the toner” of the formula (4) is determined by the following formula (5). Since the environmental fluctuation rate of the quantity of electric charge of the toner is set within the below-described predetermined range, the toner is uniformly deposited on a sheet, and heat capacity of the area of the sheet on which the toner is deposited is made uniform. Specifically, the “heat capacity of the toner” of the formula (5) is made uniform. Since the toner is heated by the planar heater, which can uniformly heat in the longitudinal direction compared to a halogen heater etc., a quantity of heat applied to the toner can be made uniform. Specifically, the “quantity of heat the toner receive” of the formula (5) is made uniform. Accordingly, the temperature rise value of the toner is made uniform to make a temperature of the toner uniform by the formulae (5) and (4), to thereby prevent uneven gloss of an image.

[Math. 4]

(Toner temperature)=(initial toner temperature)+(toner temperature rise value) (4)

(Toner temperature rise value)=(quantity of heat toner receive)/(toner heat capacity) (5)

In the present embodiment, the environmental fluctuation rate X of the electric charge of the toner is set to the range of from 45% through 85% in order to suppress uneven gloss as described above. The environmental fluctuation rate X [%] is a value determined by the following formula (6), where Q1 [μC/g] is a quantity of electric charge at the environmental temperature of 10 degrees Celsius, and relative humidity of 15%, and Q2 [μC/g] is a quantity of electric charge at the environmental temperature of 27 degrees Celsius, and relative humidity of 80%.

[Math. 5]

X=(Q1−Q2)/{(Q0)+Q2)/2} (6)

Moreover, the environmental fluctuation rate X is more preferably set to the range of from 45% through 65%. As a result, the toner is more evenly deposited on a sheet, to suppress uneven gloss of an image on the sheet.

Next, results of experiments performed to determine an effect of preventing gloss unevenness with the structure of the present embodiment will be described. In the experiments below, the presence of uneven gloss is judged with 4 patterns of Examples 1 and 2, and Comparative Examples 1 and 2.

In Example 1, a planar heater is used as a heater of a fixing device, and the environmental fluctuation rate X of the quantity of electric charge of the toner is set to 55.8%. In Example 2, a planar heater is used as a heater of a fixing device, and the environmental fluctuation rate X of the quantity of electric charge of the toner is set to 84.4%. In Comparative Example 1, a halogen heater is used as a heater of a fixing device, and the environmental fluctuation rate X of the quantity of electric charge of the toner is set to 55.8%. In Comparative Example 2, a halogen heater is used as a heater of a fixing device, and the environmental fluctuation rate X of the quantity of electric charge of the toner is set to 84.4%.

A measuring method of the quantities of electric charge of the toner Q1 and Q2 will be described.

The quantity of electric charge of the two-component developer by friction between the toner and carrier is measured by a testing method for electrostatic propensity (blow-off method). The blow-off method is described, for example, in “Blow-off method,” Journal of the Imaging Society of Japan, Vol. 37 (1998), pp. 461-470. In Examples and Comparative Examples above, the quantity of electric charge of the toner is measured by means of TB-200 Tribocharge Tester, available from TOSHIBA CORPORATION.

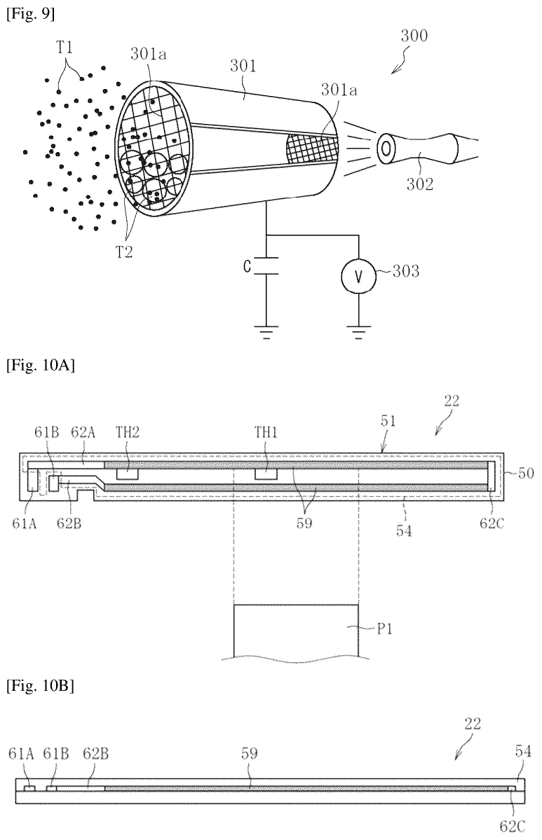

Specifically, the quantity of electric charge of the toner is measured by means of the blow-off device 300 illustrated in FIG. 9. First, the two-component developer T2 of the present embodiment is placed inside the Faraday case 301 to which wire mesh 301a (350-mesh having a diameter of 25 micrometers, 795-mesh having a diameter of 16 micrometers, both formed of stainless steel) has been arranged. The wire mesh 301a has an opening size with which the wire mesh can pass the toner, but not the carrier through. The Faraday cage 301 includes a cylindrical stainless steel container having an inner diameter of 25 mm, and a length of 35 mm, and the wire mesh 301a arranged at the both ends of the cylindrical stainless steel container. From one side of the wire mesh 301a, air (nitrogen gas) is blown by a blower 302 at the air pressure of 2.0 Kgf/cm². As a result, the charged toner T1 is sent off from the Faraday cage 301 via the other wire mesh 301a. The charge of the toner T1 sent off is determined from a mass of the toner T1 sent off, and the charge of the remained carrier. The charge of the toner T1 is inverse to the charge of the remained carrier.

The blow device used for the measurement has the following specifications.

Structure of Faraday cage: cylindrical stainless steel container having an inner diameter of 25 mm, and a length of 35 mm

Mesh: 350-mesh having a diameter of 25 micrometers, 795-mesh having a diameter of 16 micrometer, both formed of stainless steel

Air (gas): nitrogen gas (temperature: 23 degrees Celsius)

Air pressure (blow pressure): 2.0 Kgf/cm²

Temperature and humidity: 23 degrees Celsius±3 degrees Celsius, 60 RH %±10RH %

Blow time: 60 sec

Before stirring the carrier and the toner in the 100 mL ball mill pot, the humidity control is performed for 24 hours by charging a 200 mL plastic container (inner diameter: from 60 mm through 70 mm, height: from 80 mm through 90 mm) with 50 g of the carrier and 1.5 g of the toner in the above-described environmental conditions. Moreover, the measurement of blow off is performed within 30 minutes after mixing the carrier and the toner to prepare a developer.

The quantity of electric charge Q by friction between the toner base particles and the carrier is measured in the following manner. Ferrite carrier for forming developer: 48.75 g

Toner base particles: 1.25 g

A 100 mL ball mill pot is charged with the above-listed ferrite carrier and toner, and the resultant mixture is stirred for 30 minutes at 150 rpm, followed by measuring a quantity of blow-off electric charge Q according to the above-described blow-off method.

When the presence of gloss unevenness in an image is confirmed, a black solid image is continuously printed on 10 sheets.

Then, gloss unevenness in the image formed on the sheet is visually confirmed. The result where the gloss unevenness is confirmed is determined as A, the result where slight unevenness of gloss is confirmed is determined as B, and unevenness of gloss is clearly confirmed is determined as C.

The results of the experiments above are presented in Table 1.

TABLE 1

| | | Environmental | |
|---|---|---|---|
| | | fluctuation rate of | |
| | | quantity of electric | Evaluation of |
| | Heater | charge of toner (%) | gloss uneveness |
| Ex. 1 | planar heater | 55.8 | A |
| Ex. 2 | planar heater | 84.4 | B |
| Comp. Ex. 1 | halogen heater | 55.8 | C |
| Comp. Ex. 2 | halogen heater | 84.4 | C |

It is understand from Comparative Examples 1 and 2 of Table 1 that uneven gloss is generated and the result of the unevenness of gloss is C when the halogen heater is used. Particularly, even when the environmental fluctuation rate X is low as in Comparative Example 1, uneven gloss is generated. Comparing between Examples 1 and 2, moreover, even when the planar heater is used, slight unevenness is observed in gloss as the environmental fluctuation rate X is large as in Example 2. It is therefore assumed that significantly even gloss is generated even with the planar heater when the environmental fluctuation rate X is greater than the value of Example 2.

As described above, it has been found that uneven gloss is generated when the heater for use or the environmental fluctuation rate of the quantity of electric charge of the toner for is are different from those of the present embodiment. In other words, uneven gloss of an image can be effectively presented by a combination of the planar heater of the present embodiment, and the set environmental fluctuation rate of the quantity of electric charge of the toner in the present embodiment.

As the structure of the present embodiment, an image forming apparatus the speed of printing operations (fixing operations) of which is increased is applied, and the effect thereof is significantly exhibited. For example, the above-described structure is preferably applied for an image forming apparatus in which the nip time of a sheet at the fixing nip N is from 25 msec through 38 msec. In the image forming apparatus with which fixing operations are performed at high speed, the fixing belt 20 tends to be heated at a high temperature to cause uneven gloss of an image. Therefore, the above-described structure is preferably applied.

The nip time is determined by the quotient obtained by dividing the width of the fixing nip N along the sheet conveyance direction with the linear speed of the sheet at the fixing nip N. In the present embodiment, as an example, the width of the fixing nip N along the sheet conveyance direction is set to the range of from 6 mm through 9 mm, and the linear speed of the sheet at the fixing nip N is set to 230 mm/sec when the A4-size portrait sheet is printed at the speed of 40 ppm (i.e., printing to output 40 sheets per minute). The width of the fixing nip N along the sheet conveyance direction is measured using a transparent plastic sheet (e.g., a sheet for overhead projectors (OHP)) in the same manner as the above-described method for determining the width S, and the width of the sheet conveyance direction at the center of the longitudinal direction of the image is determined as the width of the fixing nip N along the sheet conveyance direction. Moreover, the linear speed can be measured by means of a Doppler velocimeter.

<Description of Toner>

Next, the toner for use in the present embodiment will be described in detail.

The toner includes toner particles, and each toner particle includes wax and a binder resin. Each of the toner particles preferably further includes a shell layer material, and may further include other components, such as a colorant, according to the necessity. The toner includes the toner particles each having a core-shell structure including a core and a shell layer. The shell layer is arranged over a surface of the core. The shell layer may cover the entire surface of the core, or part of the surface of the core. Examples of the shell layer covering part of the surface of the core include an embodiment where the shell layer is present as islands on the surface of the core. The wax and binder resin are preferably included in the core, but may be included in the shell layer.

The wax is not particularly limited, and any wax known in the art can be used. Examples thereof include: low molecular weight polyolefin wax, such as low molecular weight poly ethylene, and low molecular weight polypropylene; synthetic hydrocarbon-based wax, such as Fischer-Tropsch wax; natural wax, such as bees wax, carnauba wax, candelilla wax, rice wax, and montan wax; petroleum wax, such as paraffin wax, and microcrystalline wax; fatty acid-based wax, such as higher fatty acid (e.g., stearic acid, palmitic acid, and myristic acid), a metal salt of the higher fatty acid, and higher fatty acid amide: ester wax, such as synthetic ester wax; and various modified wax thereof. The above-listed examples may be used alone or in combination. Among the above-listed wax, carnauba wax and modified wax of carnauba wax, rice wax, and ester wax are preferable, and ester wax is particularly preferable.

(Binder Resin)

The binder resin is not particularly limited, and any of binder resins known in the art can be used. As the binder resin, a polyester resin is preferably used. Examples of the polyester resin include modified polyester and non-modified polyester. The above-listed examples may be used alone or in combination.

(Modified Polyester)

Modified polyester (i) means a state where a binding group other than an ester bond is present in a polyester resin, or a resin component having a different structure is bonded through a covalent bond or ionic bond in the polyester resin. Specifically, the modified polyester (i) is polyester, in which a functional group reactive with a carboxylic acid group and a hydroxyl group, such as an isocyanate group, is introduced at a terminal of the polyester, and the terminal thereof is reacted with an active hydrogen-containing compound to thereby modify the terminal of the polyester.

Examples of the modified polyester (i) include polyester modified with a urea bond, which is obtained through a reaction between an isocyanate group-containing polyester prepolymer (A) and amine (B) (may be referred to as “urea-modified polyester”).

Examples of the isocyanate group-containing polyester prepolymer (A) include a prepolymer obtained by reacting active hydrogen group-containing polyester, which is a condensation product between polyvalent alcohol (P) and polyvalent carboxylic acid (PC), with a polyvalent isocyanate compound (PIC). Examples of the active hydrogen group contained in the polyester include a hydroxyl group (e.g., an alcoholic hydroxyl group, and a phenolic hydroxyl group), an amino group, a carboxyl group, and a mercapto group. Among the above-listed examples, the active hydrogen group contained in the polyester is preferably an alcoholic hydroxyl group.

The polyvalent alcohol compound (PO) is not particularly limited. Examples thereof include divalent alcohol (DIO), and trivalent or higher polyvalent alcohol (TO). The polyvalent alcohol compound (PO) is preferably (DIO) alone, or a mixture of (DIO) and a small amount of (TO).

Examples of the bivalent alcohol (DIO) include: alkylene glycol (e.g., ethylene glycol, 1,2-propyleneglycol, 1,3-propyleneglycol, 1,4-butanediol, and 1,6-hexanediol); alkylene ether glycol (e.g., diethylene glycol, triethylene glycol, dipropylene glycol, polyethylene glycol, polypropylene glycol, and polytetramethylene ether glycol); alicyclic diol (e.g., 1,4-cyclohexanedimethanol, and hydrogenated bisphenol A); bisphenols (e.g., bisphenol A, bisphenol F, and bisphenol S); alkylene oxide (e.g., ethylene oxide, propylene oxide, and butylene oxide) adducts of alicyclic diol; and alkylene oxide (e.g., ethylene oxide, propylene oxide, and butylene oxide) adducts of bisphenol. The above-listed examples may be used alone or in combination. Among the above-listed examples, (DIO) is preferably C2-C12 alkylene glycol, and an alkylene oxide adduct of bisphenol, and is particularly preferably a combination of an alkylene oxide adduct of bisphenol and C2-C12 alkylene glycol.

Examples of the trivalent or higher polyvalent alcohol (TO) include trivalent to octavalent, or higher polyvalent aliphatic alcohol (e.g., glycerin, trimethylolethane, trimethylolpropane, pentaerythritol, and sorbitol); trivalent or higher phenols (e.g., trisphenol PA, phenol novolak, and cresol novolak); and alkylene oxide adducts of trivalent or higher polyphenols. The above-listed examples may be used alone or in combination.

The polyvalent carboxylic acid (PC) is not particularly limited. Examples thereof include divalent carboxylic acid (DIC), and trivalent or higher polyvalent carboxylic acid (TC). Among the above-listed examples, (PC) is preferably (DIC) alone, or a mixture of (DIC) and a small amount of (TC) is preferable.

Examples of the divalent carboxylic acid (DIC) include: alkylene dicarboxylic acid (e.g., succinic acid, adipic acid, and sebacic acid); alkenylene dicarboxylic acid (e.g., maleic acid, and fumaric acid); and aromatic dicarboxylic acid (e.g., phthalic acid, isophthalic acid, terephthalic acid, and naphthalene dicarboxylic acid). Among the above-listed examples, C4-C20 alkenylene dicarboxylic acid and C8-C20 aromatic dicarboxylic acid are preferable.

Examples of the trivalent or higher polyvalent carboxylic acid (TC) include C9-C20 aromatic polyvalent carboxylic acid (e.g., trimellitic acid and pyromellitic acid). The polyvalent carboxylic acid (PC) may be a reaction product between acid anhydride or lower alkyl ester (e.g., methyl ester, ethyl ester, and isopropyl ester) thereof and polyvalent alcohol (PO).

A ratio between the polyvalent alcohol (PO) and the polyvalent carboxylic acid (PC) is not particularly limited. The ratio thereof is determined as an equivalent ratio ([OH]/[COOH]) of hydroxyl groups [OH] to carboxyl groups [COOH], and the equivalent ratio ([OH]/[COOH]) is typically from 2/1 through 1/1, preferably from 1.5/1 through 1/1, and more preferably from 1.3/1 through 1.02/1.

The polyvalent isocyanate compound (PIC) is not particularly limited. Examples thereof include: aliphatic polyvalent isocyanate (e.g., tetramethylene diisocyanate, hexamethylene diisocyanate, and 2,6-diisocyanatomethylcaproate); alicyclic polyisocyanate (e.g., isophorone diisocyanate, and cyclohexylmethane diisocyanate); aromatic diisocyanate (e.g., tolylene diisocyanate, and diphenylmethane diisocyanate); aromatic aliphatic diisocyanate (e.g., a, a, a′, a′-tetramethylxylene diisocyanate); isocyanates; block products of alicyclic polyisocyanate with a phenol derivative, oxime, or caprolactam; and a combination thereof.

A ratio of the polyvalent isocyanate compound (PIC) is determined as an equivalent ratio ([NCO]/[OH]) of isocyanate groups [NCO] to hydroxyl groups [OH] of the hydroxyl group-containing polyester, and the equivalent ratio ([NCO]/[OH]) is typically from 5/1 through 1/1, preferably from 4/1 through 1.2/1, and more preferably from 2.5/1 through 1.5/1.

An amount of a constitutional component of the polyvalent isocyanate compound (PIC) in the isocyanate group-containing polyester prepolymer (A) is typically from 0.5% by mass through 40% by mass, preferably from 1% by mass through 30% by mass, and more preferably from 2% by mass through 20% by mass.

The amine (B) reacted with the polyester prepolymer (A) is not particularly limited. Examples thereof include a divalent amine compound (B1), a trivalent or higher polyvalent amine compound (B2), amino alcohol (B3), aminomercaptan (B4), amino acid (B5), and blocked product obtained by blocking amino groups of (B1) to (B5). The above-listed examples may be used alone or in combination.

Examples of the divalent amine compound (B1) include: aromatic diamine (e.g., phenylene diamine, diethyltoluene diamine, and 4,4′-diaminodiphenylmethane); alicyclic diamine (e.g., 4,4′-diamino-3,3′-dimethyldicyclohexylmethane, diamine cyclohexane, and isophorone diamine); and aliphatic diamine (e.g., ethylene diamine, tetramethylene diamine, and hexamethylene diamine).

Examples of the trivalent or higher amine compound (B2) include diethylene triamine, and triethylene tetramine.

Examples of the amino alcohol (B3) include ethanol amine, and hydroxyethylaniline.

Examples of the aminomercaptan (B4) include aminoethylmercaptan, aminopropylmercaptan.

Examples of the amino acid (B5) include aminopropionic acid, and aminocaproic acid.

Examples of the block product of amino groups of (B1) to (B5) include ketimine compounds and oxazolidine compounds obtained with amines of (B1) to (B5) and ketones (e.g., acetone, methyl ethyl ketone, and methyl isobutyl ketone).

Among the above-listed examples, the amine (B) is preferably (B1) alone, or a mixture of (B1) and a small amount of (B2).

A ratio of the amine (B) is determined as an equivalent ratio ([NCO]/[NHx]) of isocyanate groups [NCO] in the isocyanate group-containing polyester prepolymer (A) to amino groups [NHx] in the amine (B). The equivalent ratio ([NCO]/[NHx]) is typically from 1/2 through 2/1, preferably from 1.5/1 through 1/1.5, and more preferably from 1.2/1 through 1/1.2.

Moreover, as well as the urea bond, the urea-modified polyester may include a urethane bond. A molar ratio of the amount of the urea bond to the amount of the urethane bond is typically from 100/0 through 10/90, preferably from 80/20 through 20/80, and more preferably from 60/40 through 30/70.

The modified polyester (i) is produced by a one-shot method, or a prepolymer method.

The weight average molecular weight of the modified polyester (i) is typically 10,000 or greater, preferably from 20,000 through 10,000,000, and even more preferably from 30,000 through 1,000,000. The peak molecular weight thereof is preferably from 1,000 through 10,000.

When the below-described unmodified polyester (non-modified polyester) (ii) is used in combination, the number average molecular weight of the modified polyester (i) is not particularly limited and may be the number average molecular weight to easily achieve the above-mentioned weight average molecular weight. In case of the modified polyester (i) alone, the number average molecular weight of the modified polyester (i) is typically 20,000 or less, preferably from 1,000 through 10,000, and more preferably from 2,000 through 8,000.

A crosslink and/or elongation reaction between the polyester prepolymer (A) and the amine (B) for obtaining the modified polyester (i) may optionally use a reaction terminator to adjust a molecular weight of urea-modified polyester to be obtained. Examples of the reaction terminator include monoamines (e.g., diethylamine, dibutylamine, butylamine, and laurylamine), and block product thereof (e.g., ketimine compounds).

(Unmodified Polyester)

As well as using the modified polyester (i) alone as the binder resin, the modified polyester (i) may be used in combination with non-modified polyester (ii) as the binder resin. Use of the modified polyester (i) and the non-modified polyester (ii) in combination is preferable because low fixing ability and gloss of a resultant image obtained by means of a full-color device can be improved compared with the case where the modified polyester (i) is used alone.

Examples of the non-modified polyester (ii) include similar polycondensation products between polyvalent alcohol (PO) and polyvalent carboxylic acid (PC) to the modified polyester (i). The preferable embodiment thereof is also identical to that of the modified polyester (i). Moreover, the non-modified polyester (ii) may not be only unmodified polyester, but may be modified with a chemical bond other than a urea bond. For example, the non-modified polyester (ii) may be modified with a urethane bond.

The modified polyester (i) and the non-modified polyester (ii) may be at least partially compatible to each other considering low temperature fixing ability and hot offset resistance. Accordingly, the composition of the modified polyester (i) and the composition of the non-modified polyester (ii) are preferably similar. When the non-modified polyester (ii) is included, a weight ratio of the modified polyester (i) to the non-modified polyester (ii) is typically from 5/95 through 80/20, preferably from 5/95 through 30/70, more preferably from 5/95 through 25/75, and particularly preferably from 7/93 through 20/80.

The peak molecular weight of the non-modified polyester (ii) is typically from 1,000 through 10,000, preferably from 2,000 through 8,000, and more preferably from 2,000 through 5,000.

The hydroxyl value of the non-modified polyester (ii) is preferably 5 mgKOH/g or greater, more preferably from 10 mgKOH/g through 120 mgKOH/g, and particularly preferably from 20 mgKOH/g through 80 mgKOH/g. Moreover, the acid value of the non-modified polyester (ii) is preferably from 1 mgKOH/g through 5 mgKOH/g, and more preferably from 2 mgKOH/g through 4 mgKOH/g.

The glass transition temperature (Tg) of the binder resin is typically from 35 degrees Celsius through 70 degrees Celsius, and preferably from 55 degrees Celsius through 65 degrees Celsius.

The binder resin can be produced by the following method.

In the presence of a known esterification catalyst, such as tetrabutoxy titanate, and dibutyl tin oxide, polyvalent alcohol (PO) and polyvalent carboxylic acid (PC) are heated up to a temperature of from 150 degrees Celsius through 280 degrees Celsius, and generated water is removed optionally with reduced pressure, to thereby obtain hydroxyl group-containing polyester. Subsequently, the hydroxyl group-containing polyester is reacted with a polyvalent isocyanate compound (PIC) at a temperature of from 40 degrees Celsius through 140 degrees Celsius, to thereby obtain an isocyanate group-containing prepolymer (A).

Furthermore, the isocyanate group-containing prepolymer (A) is reacted with amine (B) at a temperature of from 0 degrees Celsius through 140 degrees Celsius, to thereby obtain a urea-modified polyester as modified polyester (i).

When the polyvalent isocyanate compound (PIC) is reacted and when the isocyanate group-containing prepolymer (A) and the amine (B) are reacted, a solvent is optionally used.

Examples of the solvent usable for the reaction include solvents inert to the polyvalent isocyanate compound (PIC). Specific examples thereof include: aromatic solvents (e.g., toluene, and xylene); ketones (e.g., acetone, methyl ethyl ketone, and methyl isobutyl ketone); esters (e.g., ethyl acetate); amides (e.g., dimethylformamide, and dimethylacetamide); and ethers (e.g., tetrahydrofuran).

When non-modified polyester (ii) is used in combination as the binder resin, non-modified polyester (ii) is produced in the same manner as the production of hydroxyl group-containing polyester, and the non-modified polyester (ii) is dissolved and mixed in the solution in which the reaction of the modified polyester (i) has been completed.

(Shell Layer Material)

The shell layer material is not particularly limited and may be appropriately selected from materials used for shell layers of toner particles known in the art. The shell layer material preferably includes a polymeric protective colloid. The polymeric protective colloid is not particularly limited. Examples thereof include: acid, such as acrylic acid, methacrylic acid, α-cyanoacrylic acid, α-cyanomethacryloc acid, itaconic acid, crotonic acid, fumaric acid, maleic acid, and maleic anhydride; a (meth)acryl-based monomer containing a hydroxyl group, such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin 1-acrylate, glycerin 1-methacrylate, N-methylol acrylamide, and N-methylol methacrylamide; vinyl alcohol or ether with vinyl alcohol, such as vinyl methyl ether, vinyl ethyl ether, and vinyl propyl ether; ester of vinyl alcohol and a compound containing a carboxyl group, such as vinyl acetate, vinyl propipnate, and vinyl acetate; a compound, such as acryl amide, methacryl amide, diacetone acryl amide, or a methylol compound thereof acid chloride, such as acrylyl chloride, and methacrylyl chloride; a homopolymer or copolymer of a nitrogen-containing compound, or a compound containing a heterocycle thereof, such as vinylpyridine, vinyl pyrrolidone, vinyl imidazole, ethylene imine; a polyoxyethylene-based compound, such as polyoxyethylene, polyoxypropylene, polyoxyethylene alkyl amine, polyoxypropylene alkyl amine, polyoxyethylene alkyl amide, polyoxypropylene alkyl amide, polyoxyethylene nonylphenyl ether, polyoxyethylene laurylphenyl ether, polyoxyethylene stearylphenyl ester, and polyoxyethylene nonylphenyl ester; and cellulose, such as methyl cellulose, hydroxyethyl cellulose, and hydroxypropyl cellulose.

The polymeric protective colloid can also function as a dispersing agent configured to stabilize dispersion of rein particles or an inorganic compound in an aqueous medium in the course of production of the toner.

(Other Components)

Other components in the toner are not particularly limited, and may be appropriately selected from known components used for a toner. Examples thereof include a colorant, a charge-controlling agent, and external additives.

(Colorant)

The colorant is not particularly limited. Any of dyes and pigments known in the art may be used. Examples of the colorant include carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, lithopone, and a mixture thereof.

The glass transition temperature (Tg) of the toner is not particularly limited and may be appropriately selected depending on the intended purpose. The glass transition temperature of the toner is preferably 40 degrees Celsius or higher but 70 degrees Celsius or lower, and more preferably 45 degrees Celsius or higher but 55 degrees Celsius or lower.

(Thickness d of Shell Layer)

The thickness d of the shell layer of the toner can be evaluated by any of the following methods 1) to 3).

1) Observation Under Transmission Electron Microscope (TEM)

First, about 1 scope of the toner is collected by a spatula and embedded in an epoxy-based resin. Then, the epoxy resin is cured. The resultant sample is dyed by exposing the sample to gas of ruthenium tetroxide or osmium tetroxide for 5 minutes to identify the shell and the core. The sample is cut by a knife to expose a cross-section to prepare an ultra-thin cut piece of the toner (thickness: 200 nm) by means of an ultramicrotome (ULTRACUT UCT, available from Leica, using a diamond knife). Thereafter, the toner is observed under transmission electron microscope (TEM, H7000, available from Hitachi High-Tech Corporation) at acceleration voltage of 100 kV.

2) Observation Under Scanning Electron Microscope (FE-SEM)

First, about 1 scope of the toner is collected by a spatula and embedded in an epoxy-based resin. Then, the epoxy resin is cured. The resultant sample is dyed by exposing the sample to gas of ruthenium tetroxide or osmium tetroxide for 5 minutes to identify the shell and the core. The sample is cut by a knife to expose a cross-section to prepare an ultra-thin cut piece of the toner (thickness: 200 nm) by means of an ultramicrotome (ULTRACUT UCT, available from Leica, using a diamond knife). Thereafter, a backscattered electron image is observed under a scanning electron microscope (FE-SEM, Ultra55, available from Zeiss) at the acceleration voltage of from 0.8 kV through 2 kV.

Islands of the shell structure can be observed by setting the toner on a sample stage without cutting the toner particles to expose cross-sections, and observing a secondary electron image or backscattered electron image of the toner. At the time of the observation, acceleration voltage may be adjusted, or platinum or carbon is deposited by vapor deposition in order to prevent charge-up of charge.

3) Evaluation by SPM

First, about 1 scope of the toner is collected by a spatula, the collected toner is embedded in an epoxy-based resin, and the epoxy-based resin is cured. The cured resin is cut by a knife to expose a cross-section of the toner, and the cross-surface of the toner is prepared by an ultramicrotome (ULTRACUT UCT, available from Leica, using a diamond knife).

Thereafter, the layer image is observed by a layer image depending on a difference in viscoelasticity or deposition by means of a scanning probe microscope (SPM, MMAFM multi-mode SPM unit, available from Veeco) with a tapping mode.

Islands of the shell structure can be observed by setting the toner on a sample stage without cutting the toner particles to expose cross-sections, and scanning the surfaces of the toner particles to visualize surface roughness information, a phase image, or a viscoelasticity image.

The thickness d of the shell layer of the toner of the present disclosure is preferably 10 nm or greater but 100 nm or less, and more preferably 10 nm or greater but 70 nm or less.

When the thickness d of the shell layer is less than 10 nm, the shell covers the majority area of the surface layer. As a result, an effect of imparting appropriate hardness to the toner may not be obtained, and a fixed image having excellent fastness may not be obtained.

When the thickness d of the shell layer is greater than 100 nm, an effect of low temperature fixing ability may be impaired.

A shape, size, etc. of the toner of the present disclosure are not particularly limited. The particles of the toner (i.e., toner particles) preferably have the following volume average particle diameter Dv, particle size distribution (volume average particle diameter/number average particle diameter Dn), and average circularity.

(Volume Average Particle Diameter Dv)

For example, the volume average particle diameter (Dv) is preferably 3 micrometers or greater but 7 micrometers or less, and more preferably 4 micrometers or greater but 6 micrometers or less.

When the volume average particle diameter is 3 micrometers or greater, in case of a two-component developer, the toner is prevented from fusing on surfaces of carrier particles due to stirring performed by a developing device over a long period, and therefore reduction in chargeability of the carrier can be prevented. When the volume average particle diameter of the toner is 7 micrometers or less, an image of high resolution and high image quality can be obtained. When the toner is consumed and supplied within the developer, variations in the particle diameter of the toner can be reduced.

(Particle Size Distribution (Volume Average Particle Diameter Dv/Number

Average Particle Diameter Dn)) The particle size distribution (volume average particle diameter Dv/number average particle diameter Dn) is preferably from 1.00 through 1.20, and more preferably from 1.10 through 1.18.

The volume average particle diameter (Dv), the number average particle diameter (Dn), and the ratio thereof (Dv/Dn), are measured by means of a particle size analyzer (“Multisizer III,” available from Beckman Coulter Inc.) with the aperture diameter of 100 micrometers, and the results are analyzed by analysis software (Beckman Coulter Multisizer 3 Version3.51). Specifically, a 100 mL glass beaker is charged with 0.5 mL of a 10% by weight surfactant solution (alkylbenzene sulfonate, NEOGEN SC-A, available from DAI-ICHI KOGYO SEIYAKU CO., LTD.). To the surfactant solution 0.5 g of the toner is added, and the resultant is stirred by a micro spatula, followed by adding 80 mL of ion-exchanged water. The obtained dispersion liquid is subjected to a dispersion treatment for minutes by means of an ultrasonic disperser (W-113MK-II, available from Honda Electronics). The resultant dispersion liquid is subjected to a measurement by means of Multisizer III with using ISOTON III (available from Beckman Coulter Inc.) as a solution for measuring. The toner sample dispersion liquid is dripped in a manner that the concentration indicated by the device is to be 8%±2%.

(Average Circularity)

The average circularity is a value obtained by dividing the circumferential length of an equivalent circle having the same area as the projected area of the shape of the toner particle with the circumferential length of the actual toner particle. For example, the average circularity is preferably from 0.950 through 0.980, and more preferably from 0.960 through 0.975.

When the average circularity is 0.950 or greater, satisfactory transferring performance and a high quality image without dust particles can be obtained. When the average circularity is 0.980 or less, moreover, excellent cleaning performance can be obtained, and therefore a high quality image can be obtained. In an image forming system employing a cleaning blade etc., for example, a cleaning performance on a photoconductor and a transfer belt is improved. Therefore, smearing on an image may be prevented.

The smearing on the image means, for example, the untransferred toner image is remained on a photoconductor due to paper feeding failures etc., during the operation for forming an image of a high imaging ratio, such as a photographic image, and the untransferred toner image is not removed by cleaning with the blade, and therefore scumming of the image on the sheet occurs during the following image formation operation. When the average circularity is within the above-mentioned range, contamination of a charging roller configured to contact-charge the photoconductor can be prevented, and the original charging capability can be sufficiently exhibited.

The average circularity is determined by a flow particle image analyzer (FPIA-3000, available from Sysmex Corporation).

A container from which solid impurities have been removed in advance is used. In 100 mL through 150 mL of water, 0.1 mL through 0.5 mL of alkyl benzene sulfonate is added as a dispersant. To the resultant, about 0.1 g through about 0.5 g of the toner is added. The suspension liquid in which the sample is dispersed is subjected to a dispersion treatment for about 1 minute to about 3 minutes by means of an ultrasonic disperser. After adjusting the concentration of the dispersion liquid to 3,000 particles per microliters through 10,000 particles per microliters, the shape and size distribution of the toner are measured by the device, to thereby determine average circularity.

The amount of the colorant relative to the toner is generally from 1% by mass through 15% by mass, preferably from 3% by mass through 10% by mass.

The colorant may be formed into a composite with a resin, and used as a master batch.

Examples of the resin used for the production of the master batch, or kneaded together with the master batch include: polymers of styrene and substituted products thereof, such as polystyrene, poly-p-chlorostyrene, and polyvinyl toluene, copolymer thereof with a vinyl compound, polymethyl methacrylate, polybutyl methacrylate, polyvinyl chloride, polyvinyl acetate, polyethylene, polypropylene, a polyester resin, an epoxy resin, an epoxy polyol resin, a polyurethane resin, a polyamide resin, a polyvinyl butyral resin, a polyacrylic acid resin, rosin, modified rosin, a terpene resin, an aliphatic or alicyclic hydrocarbon resin, and an aromatic petroleum resin. The above-listed examples may be used alone or in combination.

The master batch can be obtained by mixing or kneading the resin for a master batch and a colorant together by applying high shearing force. In order to enhance the interaction between the colorant and the resin, an organic solvent may be used. Moreover, a so-called flashing method is preferably used, since a wet cake of the colorant can be directly used without being dried. The flashing method is a method in which an aqueous paste containing water and a colorant is mixed or kneaded with a resin and an organic solvent, and then the colorant is transferred to the resin to remove the moisture and the organic solvent. In the mixing or kneading, a high-shearing disperser (e.g., a three-roll mill) is preferably used.

(Charge-Controlling Agent)

The charge-controlling agent may be any of charge-controlling agents known in the art. Examples thereof include nigrosine-based dyes, triphenylmethane-based dyes, a chrome-containing metal complex dyes, molybdic acid chelate pigments, rhodamine-based dyes, alkoxy-based amine, quaternary ammonium salts (including fluorine-modified quaternary ammonium salts), alkylamide, phosphorus or phosphorus compounds, tungsten or tungsten compounds, fluorine-based active agents, metal salts of salicylic acid, and metal salts of salicylic acid derivatives.

Specific examples of the charge-controlling agent include: a nigrosine-based dye BONTRON 03, quaternary ammonium salt BONTRON P-51, a metal-containing azo dye BONTRON S-34, an oxynaphthoic acid-based metal complex E-82, a salicylic acid-based metal complex E-84, and a phenol condensate E-89 (available from ORIENT CHEMICAL INDUSTRIES CO., LTD.); quaternary ammonium salt molybdenum complex TP-302, and TP-415 (available from Hodogaya Chemical Co., Ltd.); quaternary ammonium salt Copy Charge PSY VP2038, a triphenylmethane derivative Copy Blue PR, a quaternary ammonium salt Copy Charge NEG VP2036, and Copy Charge NX VP434 (available from Hoechst AG); LRA-901, and a boron complex LR-147 (available from Japan Carlit Co., Ltd.); copper phthalocyanine; perylene; quinacridone; azo-pigments; and polymeric compounds having, as a functional group, a sulfonic acid group, carboxyl group, and quaternary ammonium salt. The above-listed examples may be used alone or in combination. Among the above-listed examples, a charge-controlling agent capable of adjusting polarity of the toner to negative is particularly preferably used.

An amount of the charge-controlling agent for use cannot be stated unambiguously because the amount thereof is determined depending on a binder resin for use the presence of optionally used additives, and a production method of a toner including a dispersion method. However, the amount of the charge-controlling agent used relative to 100 parts by mass of the binder resin is preferably from 0.1 parts by mass through 10 parts by mass, and more preferably from 0.2 parts by mass through 5 parts by mass.

(External Additives)

As external additives, any of external additives known in the art can be used. Examples of the external additives include inorganic particles, and organic particles. Among the above-listed examples, the inorganic particles are preferably used as external additives for aiding flowability of the toner particles, developability, and chargeability.

The primary particle diameter of the inorganic particles is not particularly limited. The primary particle diameter thereof is preferably from 5×10⁻³ micrometers through 2 micrometers, and particularly preferably from 5×10⁻³ micrometers through 0.5 micrometers.

The BET specific surface area of the inorganic particles is not particularly limited. The BET specific surface area thereof is preferably from 20 m²/g through 500 m²/g.

A ratio of the inorganic particles used relative to the toner is not particularly limited. The ratio thereof relative to the toner is preferably from 0.01% by mass through 5% by mass, and particularly preferably from 0.01% by mass through 2.0% by mass.

Specific examples of the inorganic particles include silica, alumina, titanium oxide, barium titanate, magnesium titanate, calcium titanate, strontium titanate, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride. Specific examples of the organic particles include: polymer particles of polystyrene etc. obtained by a soap-free emulsion polymerization method, a suspension polymerization method, or a dispersion polymerization method; particles of copolymers of methacrylic acid esters or acrylic acid esters; polycondensate-based particles, such as silicone, benzoguanamine, and nylon; and polymer particles of thermoset resins. The above-listed examples may be used alone or in combination.

A surface treatment is preferably performed on the external additives to improve hydrophobicity because deterioration in flowability or chargeability can be prevented even in the environment of high humidity.

Examples of a surface-treating agent used for the external additives include silane coupling agents (e.g., a fluoroalkyl group-containing silane coupling agent), sililation agents, organic titanate-based coupling agents, aluminium-based coupling agents, silicone oil, and modified silicone oil.

Among the above-listed examples, hydrophobic silica and hydrophobic titanium oxide obtained by performing a surface treatment on silica and titanium oxide, respectively, are preferably used the external additives.

The toner may be used as a one-component magnetic or non-magnetic toner without using a magnetic carrier. Moreover, the toner may be mixed with a magnetic carrier to form into and use as a two-component developer.

The magnetic carrier is not particularly limited, but the magnetic carrier is preferably ferrite particles including a bivalent metal (e.g., iron, magnetite, manganese (Mn), zinc (Zn), and copper (Cu)) and having the volume average particle diameter of from 20 micrometers through 100 micrometers. Moreover, Zn-containing Cu ferrite is preferably because of high saturation magnetization thereof. The magnetic carrier may be appropriately selected depending on a process of the image forming apparatus.

The resin for coring the magnetic carrier is not particularly limited. Examples thereof include a silicone resin, a styrene-acryl resin, a fluororesin, and an olefin resin.

As a production method of the magnetic carrier, a resin coated with a resin (i.e., a coating resin) may be dissolved in a solvent to prepare a coating solution, and the coating solution is sprayed on core particles in the fluidized bed thereof to coat the core particles with the coating resin. Alternatively, resin particles are electrostatically deposited on core particles, followed by heating and melting to coat the core particles with the resin.

The thickness of the coating resin is not particularly limited. The thickness thereof is preferably from 0.05 micrometers through 10 micrometers, and more preferably from 0.3 micrometers through 4 micrometers.

(Production Method of Toner)

A production method of the toner will be described hereinafter. As a preferable embodiment of the production method of core particles of the toner, a so-called dissolution suspension method will be described. However, the production method of the toner is not limited to the dissolution suspension method, and the toner may be core particles of the toner formed by other methods, such as a pulverization method, and an (emulsification) aggregation method.

The production of the toner is preferably performed by the following 1) to 4), and the production method more preferably further include the following 5).

1) An isocyanate group-containing polyester prepolymer (A) and wax, preferably non-modified polyester (i), and optionally a colorant are dispersed in an organic solvent to prepare a toner material liquid (also referred to as a core material liquid).

The organic solvent is nor particularly limited. The organic solvent is preferably a volatile organic solvent having a boiling point of lower than 100 degrees Celsius because the organic solvent can be easily removed after forming toner base particles. Specific examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethlidene, methyl acetate, ethyl acetate, methyl ethyl ketone, and methyl isobutyl ketone. The above-listed examples may be used alone or in combination.

Among the above-listed examples, the organic solvent is particularly preferably an aromatic solvent (e.g., toluene, and xylene), and halogenated hydrocarbon (e.g., ethylene chloride, 1,2-dichloroethane, chloroform, and carbon tetrachloride).

The amount of the organic solvent is typically 0 parts by mass through 300 parts by mass, preferably from 0 parts by mass through 100 parts by mass, and more preferably from 25 parts by mass through 70 parts by mass, relative to 100 parts by mass of the isocyanate group-containing polyester prepolymer A.

2) The toner material liquid obtained in 1) is emulsified in an aqueous medium. In order to facilitate dispersion of the toner material in the aqueous medium, a dispersant, such as a surfactant, resin particles, and an inorganic compound, may be appropriately added.

The aqueous medium may be water alone, or may include water and an organic solvent, such as alcohols (e.g., methanol, isopropyl alcohol, and ethylene glycol), dimethyl formamide, tetrahydrofuran, cellosolve (e.g., methyl cellosolve), and lower ketones (e.g., acetone, and methyl ethyl ketone).

The amount of the aqueous medium is typically from 50 parts by mass through 2,000 parts by mass, and preferably from 100 parts by mass through 1,000 parts by mass, relative to 100 parts by mass of the toner material solution.

Tg of the resin particles dispersed in the aqueous medium is preferably from 50 degrees Celsius through 110 degrees Celsius, more preferably from 50 degrees Celsius through 90 degrees Celsius, and even more preferably from 50 degrees Celsius through 70 degrees Celsius. Moreover, the weight average molecular weight of the resin particles is preferably 100,000 or less, and more preferably 50,000 or less, and the lower limit of the weight average molecular weight thereof is typically 4,000.

The surfactant is not particularly limited. Examples thereof include: anionic surfactants, such as alkyl benzene sulfonate, α-olefin sulfonic acid salt, and phosphonic acid ester; amine salt-based cationic surfactants, such as alkyl amine salt, an amine alcohol fatty acid derivative, a polyamine fatty acid derivative, and imidazoline; quaternary ammonium salt-based cationic surfactants, such as alkyl trimethyl ammonium salt, dialkyl dimethyl ammonium salt, alkyl dimethylbenzyl ammonium salt, pyridinium salt, alkyl isoquinolinium salt, and benzethonium chloride; nonionic surfactants, such as a fatty acid amide derivative, and a polyvalent alcohol derivative; and amphoteric surfactants, such as alanine, dodecyl di(aminoethyl)glycine, di(octylaminoethypglycine, and N-alkyl-N,N-dimethyl ammonium betaine. The above-listed examples may be used alone or in combination.

Moreover, use of a fluoroalkyl group-containing surfactant can improve the effect thereof with a small amount thereof.

Examples of the preferably used fluoroalkyl group-containing anionic surfactant include C2-C10 fluoroalkyl carboxylic acid and a metal salt thereof, disodium perfluorooctane sulfonyl glutamate, sodium 3-[⋅-fluoroalkyl(C6-C11)oxy)-1-alkyl(C3-C4) sulfonate, sodium 3-[ω-fluoroalkanoyl(C6-C8)-N-ethylamino]-1-propanesulfonate, fluoroalkyl(C11-C20) carboxylic acid or a metal salt thereof, perfluoroalkylcarboxylic acid(C7-C13) or a metal salt thereof, perfluoroalkyl(C4-C12)sulfonate or a metal salt thereof, perfluorooctanesulfonic acid diethanol amide, N-propyl-N-(2-hydroxyethyl)perfluorooctanesulfone amide, perfluoroalkyl(C6-C10)sulfone amide propyltrimethyl ammonium salt, a salt of perfluoroalkyl(C6-C10)-N-ethylsulfonylglycin and monoperfluoroalkyl(C6-C16) ethylphosphate. The letter “C” denotes the number of carbon atoms.

Examples of commercial products (product names) of the fluoroalkyl group-containing anionic surfactant include: SURFLON S-111, SURFLON S-112, and SURFLON S-113 (available from AGC SEMI CHEMICAL CO., LTD.); FLUORAD FC-93, FLUORAD FC-95, FLUORAD FC-98, and FLUORAD FC-129 (available from Sumitomo 3M Limited); UNIDYNE DS-101, and UNIDYNE DS-102 (available from DAIKIN INDUSTRIES, LTD.); MEGAFACE F-110, MEGAFACE F-120, MEGAFACE F-113, MEGAFACE F-191, MEGAFACE F-812, and MEGAFACE F-833 (available from DIC CORPORATION); EFTOP EF-102, EFTOP EF-103, EFTOP EF-104, EFTOP EF-105, EFTOP EF-112, EFTOP EF-123A, EFTOP EF-123B, EFTOP EF-306A, EFTOP EF-501, EFTOP EF-201, and EFTOP EF-204 (available from MITSUBISHI MATERIALS ELECTRONIC CHEMICALS CO., LTD.); and FTERGENT 100, and FTERGENT 150 (available from NEOS COMPANY LIMITED).

Moreover, examples of the fluoroalkyl group-containing cationic surfactant include aliphatic primary or secondary amine acid including a fluoroalkyl group, aliphatic quaternary ammonium salt (e.g., perfluoroalkyl (C6-C10) sulfonamidopropyl trimethyl ammonium salt), benzalkonium salt, benzethonium chloride, pyridinium salt, and imidazolium salt.

Examples of commercial products (product names) of the fluoroalkyl group-containing cationic surfactant include: SURFLON S-121 (available from AGC SEMI CHEMICAL CO., LTD.); FLUORAD FC-135 (available from Sumitomo 3M Limited); UNIDYNE DS-202 (available from DAIKIN INDUSTRIES, LTD.); MEGAFACE F-150, and MEGAFACE F-824 (available from DIC CORPORATION); EFTOP EF-132 (available from MITSUBISHI MATERIALS ELECTRONIC CHEMICALS CO., LTD.); and FTERGENT 300 (available from NEOS COMPANY LIMITED).

As the resin particles, any resin particles may be used as long as the resin particles can form an aqueous dispersion. The resin of the resin particles may be a thermoplastic resin or a thermoset resin. Examples of the resin of the resin particles include a vinyl-based resin, a polyurethane resin, an epoxy resin, and a polyester resin. The above-listed examples may be used alone or in combination.

Among the above-listed examples, a vinyl-based resin, a polyurethane resin, an epoxy resin, a polyester resin, a polystyrene resin, or a combination thereof is preferable because an aqueous dispersion of fine spherical resin particles can be easily formed.

The vinyl-based resin is a polymer obtained by homopolymerizing or copolymerizing vinyl-based monomers. Examples thereof include a styrene-acrylic acid ester resin, a styrene-methacrylic acid ester resin, a styrene-butadiene copolymer, an acrylic acid-acrylic acid ester polymer, a methacrylic acid-acrylic acid ester polymer, a styrene-acrylonitrile copolymer, styrene-maleic anhydride copolymer, styrene-acrylic acid copolymer, and styrene-methacrylic acid copolymer.

Specific examples of the resin particles include polymethyl methacrylate particles, polystyrene particles, and poly(styrene-acrylonitrile) particles.

Examples of commercial products (product names) of the resin particles include PB-200H (available from Kao Corporation), SGP-3G (available from Soken Chemical & Engineering Co., Ltd.), Technopolymer SB (available from Sekisui Kasei Co., Ltd.), and Micropeal (available from SEKISUI CHEMICAL CO., LTD.).

The resin particles are added for the purpose of stabilizing toner base particles to be formed in an aqueous medium, or preventing wax from exposing to the outermost surface of the toner base particle. Therefore, the resin particles are preferably added so that the covering rate of the surfaces of toner base particles with the resin particles is to be from 10% through 90%.

The volume average particle diameter of the resin particles is a value determined by a light scattering spectrometer (available from Ostuka Electronics Co., Ltd.), and is preferably from 200 nm through 300 nm.

The inorganic compound is not particularly limited. Examples thereof include tricalcium phosphate, calcium carbonate, titanium oxide, colloidal silica, and hydroxyapatite.

A method for dispersing is not particularly limited. Conventional equipment, such as a low-speed shearing disperser, a high-speed shearing disperser, a friction disperser, a high-pressure jet disperser, and an ultrasonic disperser, may be used. Among the above-listed examples, a high-speed shearing disperser is preferably used for adjusting particle diameters of dispersed elements to the range of from 2 micrometers through 20 micrometers. When a high-speed shearing disperser is used, the rotational speed is not particularly limited, but the rotational speed is typically from 1,000 rpm through 30,000 rpm, and preferably from 5,000 rpm through 20,000 rpm. The dispersion time is not particularly limited. In case of the batch system, the dispersion time is typically from 0.1 minutes through 5 minutes. The temperature for dispersing is typically from 0 degrees Celsius through 150 degrees Celsius (under pressure), and preferably from 40 degrees Celsius through 98 degrees Celsius.

3) At the same time as the production of the emulsified liquid, amine (B) is added to allow the amine (B) to react with the isocyanate group-containing polyester prepolymer (A).

The reaction involves crosslink and/or elongation of the molecular chain. The reaction time is not particularly limited and may be appropriately selected depending on reactivity between the isocyanate group structure of the polyester prepolymer (A) and the amine (B). The reaction time is typically from 10 minutes through 40 hours, and preferably from 2 hours through 24 hours. The reaction temperature is not particularly limited. The reaction temperature is typically from 0 degrees Celsius through 150 degrees Celsius, and preferably from 40 degrees Celsius through 98 degrees Celsius. Moreover, a known catalyst may be used according to the necessity. Specific examples of the catalyst include dibutyl tin laurate, and dioctyl tin laurate.

4) After completing the reaction of 3), the organic solvent is removed from the obtained emulsified dispersed elements (i.e., a reaction product), followed by washing and drying, to thereby obtain toner base particles. In order to remove the organic solvent, the entire system is gradually heated with stirring to give a laminar flow, and strong stirring is performed at the predetermined temperature range, followed by removing the solvent, to thereby produce toner base particles each in the shape of a spindle. When a dispersing agent that is dissolved in acid or alkali, such as calcium phosphate, is used, calcium phosphate is dissolved with acid, such as hydrochloric acid, followed by washing with water to remove the calcium phosphate from the toner base particles. Moreover, such a dispersing agent can be also removed by decomposing the dispersing agent with an enzyme.

5) To the toner base particles obtained in 4), a charge-controlling agent is optionally added, followed by externally adding inorganic particles (e.g., silica particles and titanium oxide particles) as external additives, to thereby obtain a toner.

The deposition of the charge-controlling agent and external addition of the inorganic particles may be performed by a method known in the art, such as a method using a mixer. As a result, a toner including particles of small particle diameters and a sharp particle size distribution can be easily obtained. Since string stirring is applied in the step for removing the organic solvent, shapes of the particles can be controlled from spheres to shapes like a rugby ball, and moreover, the morphology of the surface of each particle can be controlled from a smooth surface to a wrinkled surface.

Next, production methods of the toner of the present embodiment and a two-component developer will be described. In the description below, “part(s)” denotes “part(s) by mass” unless otherwise stated.

In all of Examples, the identical magnetic carrier is used as a magnetic carrier used in a two-component developer.

(Production of Magnetic Carrier)

Core particles: Cu—Zn ferrite particles (weight average particle diameter: micrometers) 5,000 parts

Coat Materials:
toluene 450 parts
silicone resin SR2400
(available from Dow Toray Co., Ltd., non-volatile component: 50%) 450 parts
aminosilane SH6020
(available from Dow Toray Co., Ltd.) 10 parts
carbon black 10 parts

The coat materials are dispersed by a stirrer for 10 minutes to prepare a coating liquid. A coating device is charged with the coating liquid and the core particles to apply the coating liquid onto each of the core particles. The coating device includes a rotary bottom plate disk and a stirring blade in a fluidized bed and is configured to perform coating with forming a swirl flow. The obtained coated particles are baked for 2 hours in an electric furnace at 250 degrees Celsius, to obtain a magnetic carrier, in which the carrier particles are each covered with the coating of the silicone resin having the average thickness of 0.5 micrometers.

(Production of Two-Component Developer)

To 100 parts by mass of the magnetic carrier, 7 parts by mass of the below-described toner are homogeneously mixed by means of a turbular mixer configured to perform stirring with rolling the container of the mixer to charge the toner and the magnetic carrier, to thereby produce a two-component developer.

(Preparation of Vinyl Resin Dispersion Liquid 1)

A reaction vessel equipped with a stirring rod and a thermometer is charged with 683 parts of ion-exchanged water, 11 parts of sodium salt of sulfuric acid ester of methacrylic acid-ethylene oxide adduct (ELEMINOL RS-30, available from Sanyo Chemical Industries, Ltd.), 10 parts of polylactic acid, 60 parts of styrene, 100 parts of methacrylic acid, 70 parts of butyl acrylate, and 1 part of ammonium persulfate. The resultant mixture is stirred for 30 minutes at the rotational speed of 3,800 rpm, followed by heating to 75 degrees Celsius to allow the mixture to react for 4 hours. To the resultant, 30 parts of a 1% by mass ammonium persulfate aqueous solution is added, and the mixture is matured for 6 hours at 75 degrees Celsius, to thereby obtain [Vinyl resin dispersion liquid 1] as an aqueous dispersion liquid of a vinyl resin. The volume average particle diameter of [Vinyl resin dispersion liquid 1] is measured by means of a laser diffraction/scattering particle size analyzer (LA-920, available from HORIBA, Ltd.), and the result is 280 nm. Part of [Vinyl resin dispersion liquid 1] is dried to separate the vinyl resin included in [Vinyl resin dispersion liquid 1]. The vinyl resin has Tg of 59 degrees Celsius, and the weight average molecular weight of 60,000.

(Preparation of Aqueous Phase)

Water (990 parts), 83 parts of [Vinyl resin dispersion liquid 1], 37 parts of a 48.3% by mass sodium dodecyldiphenyl ether disulfonate aqueous solution (ELEMINOL MON-7, available from Sanyo Chemical Industries, Ltd.), and 90 parts of ethyl acetate are mixed together and stirred, to thereby obtain a milky white liquid. The obtained milky white liquid is used as [Aqueous phase 1].

(Synthesis of Low Molecular Weight Polyester)

A reaction vessel equipped with a cooling tube, a stirrer, and a nitrogen-inlet tube is charged with 724 parts of a bisphenol A ethylene oxide (2 mol) adduct, and 276 parts of terephthalic acid, and the resultant mixture is allowed to react through polycondensation for 7 hours at 230 degrees Celsius under the atmospheric pressure. The resultant is further reacted for 5 hours under the reduced pressure of from 10 mmHg through mmHg, to thereby obtain [Low molecular weight polyester 1]. [Low molecular weight polyester 1] has the number average molecular weight of 2,300, the weight average molecular weight of 6,700, the peak molecular weight of, Tg of 43 degrees Celsius, and the acid value of 4 mgKOH/g.

(Synthesis of Intermediate Polyester)

A reaction vessel equipped with a cooling tube, a stirrer, and a nitrogen-inlet tube is charged with 682 parts of a bisphenol A ethylene oxide (2 mol) adduct, 81 parts of a bisphenol A propylene oxide (2 mol) adduct, 283 parts of terephthalic acid, 22 parts of trimellitic anhydride, and 2 parts of dibutyl tin oxide. The resultant mixture is allowed to react for 7 hours at 230 degrees Celsius under the atmospheric pressure, and is further allowed to react for 5 hours under the reduced pressure of from 10 mmHg through 15 mmHg, to thereby obtain [Intermediate polyester 1].

[Intermediate polyester 1] has the number average molecular weight of 2,200, the weight average molecular weight of 9,700, the peak molecular weight of 3,000, Tg of 54 degrees Celsius, the acid value of 0.5 mgKOH/g, and the hydroxyl value of 52 mgKOH/g.

Next, a reaction vessel equipped with a cooling tube, a stirrer, and a nitrogen-inlet tube is charged with 410 parts of [Intermediate polyester 1], 89 parts of isophorone diisocyanate, and 500 parts of ethyl acetate, and the resultant mixture is allowed to react for 5 hours at 100 degrees Celsius, to thereby obtain [Prepolymer 1]. The free isocyanate rate (%) of [Prepolymer 1] is 1.53% by mass.

(Synthesis of Ketimine)

A reaction vessel set with a stirring rod and a thermometer is charged with 170 parts of isophorone diamine, and 75 parts of methyl ethyl ketone. The resultant mixture is allowed to react for 4.5 hours at 50 degrees Celsius, to thereby obtain [Ketimine compound 1]. The amine value of [Ketimine compound 1] is 417 mgKOH/g.

(Synthesis of Master Batch)

By means of a FM mixer (available from NIPPON COKE & ENGINEERING CO., LTD.), 1,200 parts of water, 540 parts of carbon black (Printex35, available from Degussa AG) having DBP oil absorption of 42 mL/100 g and pH of 9.5, and 1,200 parts of a polyester resin were mixed. The obtained mixture is kneaded by means of two rolls for 1 hour at 130 degrees Celsius, followed by rolling and cooling the kneaded product. The resultant is pulverized by means of a pulverizer to thereby obtain [Master batch 1].

(Production of Oil Phase)

A reaction vessel equipped with a stirring rod and a thermometer is charged with 378 parts of [Low molecular weight polyester 1], 100 parts of carnauba wax, and 947 parts of ethyl acetate. The resultant mixture is heated to 80 degrees Celsius with stirring, the temperature is maintained at 80 degrees Celsius for 5 hours, followed by cooling to 30 degrees Celsius over 1 hour. Subsequently, the vessel is further charged with 500 parts of [Master batch 1] and 500 parts of ethyl acetate, and the resultant mixture is stirred for 1 hour, to thereby obtain [Raw material solution 1].

[Raw material solution 1] (1,324 parts) is transferred into a container. By means of a bead mill (Ultraviscomill, available from IMEX Co., Ltd.), the carbon black and the wax therein are dispersed by passing through e times under conditions that a feeding speed is 1 kg/h, a disk rim speed is 6 m/sec, and zirconium beads having a particle diameter of 0.5 mm are packed at 80% by volume. To the resultant, 1,324 parts of a 65% by mass [Low molecular weight polyester 1] ethyl acetate solution is added. The resultant mixture is then passed twice through the bead mill under the above-described conditions, to thereby obtain [Pigment-wax dispersion liquid 1]. The solid content of [Pigment-wax dispersion liquid 1] is 50% by mass.

(Emulsification)

A container is charged with 749 parts of [Pigment-wax dispersion liquid 1], 115 parts of [Prepolymer 1], and 2.9 parts of [Ketimine compound 1], and the resultant mixture is mixed by means of TK Homomixer (available from PRIMIX Corporation) at the rotational speed of 5,000 rpm for 2 minutes, followed by adding 1,200 parts of [Aqueous phase 1] to the container. The resultant mixture is mixed by means of TK Homomixer at the rotational speed of 13,000 rpm for 25 minutes, to thereby obtain [Emulsified slurry 1].

(Removal of Solvent)

A container set with a stirrer and a thermometer is charged with [Emulsified slurry 1]. The solvent therein is removed for 7 hours at 30 degrees Celsius, followed by maturing the slurry for 7 hours at 45 degrees Celsius, to thereby obtain [Dispersion slurry 1].

(Washing)

After performing vacuum filtration of 100 parts of [Dispersion slurry 1], I: To the obtained filtration cake, 100 parts of ion-exchanged water is added, and the resultant is mixed by means of TK Homomixer (for 10 minutes at the rotational speed of 12,000 rpm), followed by filtering the mixture.

II: To the filtration cake obtained from I, 100 parts of a 10% by mass sodium hydroxide aqueous solution is added, and the resultant is mixed by means of TK Homomixer (for 10 minutes at the rotational speed of 12,000 rpm), followed by vacuum filtering the mixture.

III: To the filtration cake obtained from II, 100 parts of 10% by mass hydrochloric acid is added, and the resultant is mixed by means of TK Homomixer (for 10 minutes at the rotational speed of 12,000 rpm), followed by filtering the mixture.

IV: To the filtration cake obtained from III, 300 parts of ion-exchanged water is added, and the resultant is mixed by means of TK Homomixer (for 10 minutes at the rotational speed of 12,000 rpm), followed by filtering the mixture. This series of processes are performed twice, to thereby obtain [Filtration cake 1].

(Drying)

[Filtration cake 1] is dried by an air circulation dryer for 48 hours at 45 degrees Celsius, and the resultant is sieved through a mesh having an opening size of 75 micrometers, to thereby obtain [Toner base particles 1]. Thereafter, 100 parts of [Toner base particles 1] are mixed with 1 part of hydrophobic silica and 1 part of hydrophobic titanium oxide by means of the FM mixer, to thereby obtain [Toner 1].

### Description of Another Embodiment

Next, another embodiment of the heater 22 will be described.

As illustrated in FIGS. 10A and 10B, the conductor layer 51 of the heater 22 of the present disclosure includes two resistance heating elements 59, a first electrode unit 61A and a second electrode unit 61B, and first to third power supply lines 62A to 62C.

Each resistance heating element 59 is in the shape of a straight line extending in the longitudinal direction. One resistance heating element 59 is electrically connected to the first electrode unit 61A via the first power supply line 62A. The other resistance heating element 59 is electrically connected to the second electrode unit 61B via the second power supply line 62B. The two resistance heating elements 59 are electrically connected via the third power supply line 62C at the other side of the longitudinal direction.

In the present disclosure, the two resistance heating elements 59 are electrically connected in series. The resistance heating elements 59 generate heat as voltage is applied to the first electrode unit 61A and the second electrode unit 61B.

Relative to the longitudinal direction, the first thermistor TH1 is disposed inside the feeding region of the minimum width sheet P1 fed through the fixing device 30. Moreover, the second thermistor TH2 is disposed adjacent to the edge of the resistance heating element 59 relative to the longitudinal direction.

The control unit disposed in the image forming apparatus is configured to control the temperature of the heater based on the temperature detected by the first thermistor TH1. Moreover, the control unit is configured to judge the presence of temperature variations of the heater 22 along the longitudinal direction based on the temperature detected by the second thermistor TH2. When the temperature difference between the temperature detected by the thermistor TH1 and the temperature detected by the thermistor TH3 exceeds the predetermined threshold, moreover, the image forming apparatus proceeds with operation for reducing the temperature unevenness.

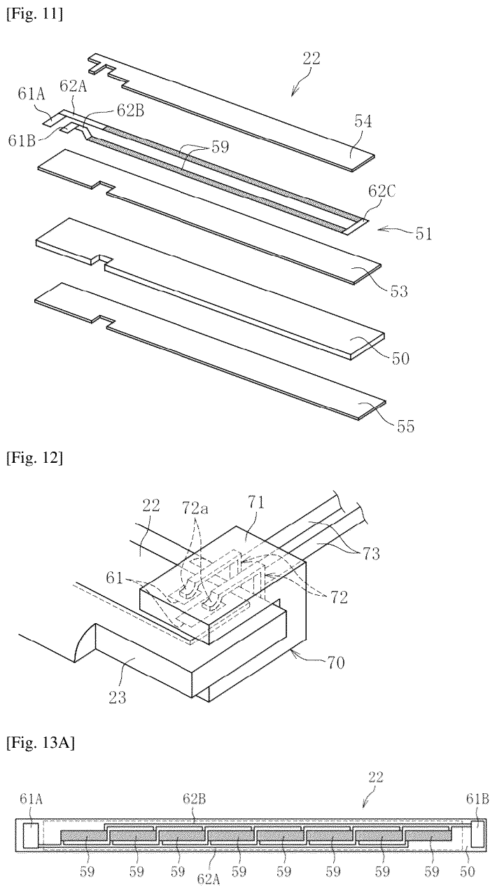

FIG. 11 is an exploded perspective view of the heater 22 illustrated in FIGS. 10A and 10B. In the description below, the side of the fixing belt (i.e., the fixing nip side) relative to the heater 22 is referred to as a “front side” and the side of the heater holder 23 is referred to as a “back side.”

As illustrated in FIG. 11, the heater 22 has a laminate structure. Specifically, the heater 22 includes a base 50, a first insulating layer 53, a conductor layer 51, a second insulating layer 54, and a third insulating layer 55. The first insulating layer 53 is disposed at the front side of the base 50. The conductor layer 51 is disposed at the front side of the first insulating layer 53. The second insulating layer 54 covers the front side of the conductor layer 51. The third insulating layer 55 is disposed at the back side of the base 50.

In order to secure connection with the below-described connector, at least part of each of the electrode units 61A and 61B is exposed without being covered with the second insulating layer 54.

FIG. 12 is a perspective view illustrating a state where the connector 70 is attached to the heater 22 and the heater holder 23. As illustrated in FIG. 12, the connector 70 includes a housing 71 formed of a resin, and a contact terminal 72 that is a plate spring and fixed on the housing. The contact terminal 72 has a pair of contact parts 72a that are in contact with the electrodes sections 61 of the heater 22, respectively. Moreover, harness 73 for power supply is connected to the connector 70 (i.e., the contact terminal 72).

The connector 70 is attached to nip the heater 22 and the heater holder 23 together from the front side and the back side. Each of the contact parts 72a of the contact terminal 72 is elastically brought into contact with (i.e., is pressed against) the electrode unit 61. As a result, the resistance heating element 59 is electrically connected to a power source mounted in the image forming apparatus via the connector 70, to create a state where electricity can be supplied from the power source to the resistance heating element 59.

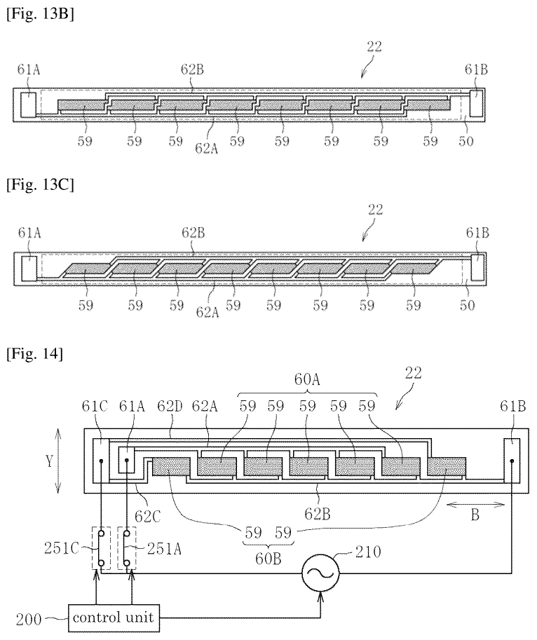

As illustrated in FIG. 13A, the conductor layer 51 of the heater of the present embodiments includes a plurality of (i.e., 8) resistance heating elements 59, a first electrode unit 61A and a second electrode unit 61B, and a first power supply line 62A and a second power supply line 62B.

Each resistance heating element 59 is connected to the first electrode unit 61A via the first power supply line 62A, and is connected to the second electrode unit 61B via the second power supply line 62B.

Each resistance heating element 59 may be in the shape of a rectangle, as illustrated in FIG. 13A or FIG. 13B, or may be in the shape of a parallelogram as illustrated in FIG. 13C. In FIGS. 13B and 13C, the terminals of the resistance heating element 59 are overlapped with one another in the longitudinal direction.

The resistance heating element 59 of the present embodiment has characteristics of a positive temperature coefficient (PTC), which may be referred to as PTC characteristics hereinafter. It is needless to say that a resistance heating element 59 having PTC characteristics may be employed in another embodiment. The PTC characteristics are characteristics that a resistance value increases as a temperature increases (i.e., output of the heater decreases when constant voltage is applied). Since the resistance heating element 59 has the PTC characteristics, the fixing device 30 can start up at high speed with high output at a low temperature, and can prevent overheating due to low output at a high temperature. When a temperature coefficient of resistance (TCR) of the PTC characteristics is set to about from 300 ppm/degrees through about 4,000 ppm/degrees, cost can be reduced. More preferably, the TCR is set to about 500 ppm/degrees through about 2,000 ppm/degrees.

The TCR can be calculated using the following formula (7). In the formula (7), TO is a standard temperature, T1 is an arbitrary temperature, R0 is a resistance value at the standard temperature TO, and R1 is a resistance value at the arbitrary temperature T1. When the resistance value between the first electrode unit 61A and second electrode unit 61B of the heater 22 is 10Ω (the resistance value R0) at 25 degrees Celsius (the standard temperature T0), and 12Ω (the resistance value R1) at 125 degrees Celsius (the arbitrary temperature T1), for example, the TCR is determined as 2,000 ppm/degrees Celsius according to the formula (7). When the resistance value between the first electrode unit 61A and second electrode unit 61B of the heater 22 illustrated in FIG. 7 is 10Ω (the resistance value R0) at 25 degrees Celsius (the standard temperature T0), and 12Ω (the resistance value R1) at 125 degrees Celsius (the arbitrary temperature T1), for example, the TCR is 2,000 ppm/degrees Celsius according to the formula (7).

[Math. 6]

Temperature coefficient of resistance (TCR)=(R1−R0)/R0/(T1−T0)×10⁶ (7)

As illustrated in FIG. 14, in the present embodiment, the first heating unit 60A and the second heating unit 60B are each independently controlled to generate heat. Among a plurality of resistance heating element 59 aligned along the longitudinal direction of the base, the first heating unit 60A includes the resistance heating elements 59 other than the resistance heating elements 59 aligned at the both ends. The second heating unit 60B includes the resistance heating elements 59 aligned at the both ends. Specifically, the resistance heating elements 59 that constituting the first heating unit 60A and excluding the resistance heating elements 59 aligned at the both ends are each contacted to the first electrode unit 61A disposed to the one end relative to the base 50 of the longitudinal direction via the first power supply line 62A. Moreover, the resistance heating elements 59 constituting the first heating unit 60A are each connected to the second electrode unit 61B disposed at the opposite end to the side of the first electrode unit 61A via the second power supply line 62B. The resistance heating elements 59 at the both ends constituting the second heating unit 60B are each connected to the third electrode unit C disposed at one end relative to the longitudinal direction of the base 50 (but different from the end where the first electrode unit 61A is disposed) via a third power supply line 62C or a fourth power supply line 62D. Moreover, the resistance heating elements 59 at the both ends are each connected to the second electrode unit 61B via the second power supply line 62B, similarly to the resistance heating elements of the first heating unit 60A.

Moreover, the electrode units 61A to 61C are each connected to the power source 210 via the connector 70 (see FIG. 12) to supply electricity from the power source 210 to the electrode units 61A to 61C. A switch 251A is disposed between the electrode unit 61A and the power source 210, and application of the voltage can be switched between on and off by turning the switch 251A on and off. Similarly, a switch 251C serving as a switching unit is disposed between the electrode unit 61C and the power source 210, and application of the voltage can be switched between on and off by turning the switch 251C on and off. Moreover, on and off of the switches 251A and 251C, and timing for supplying electricity to the heater 22 are controlled by the control unit 200. Moreover, the control unit 200 is configured to control the switches and the timing based on the detection results from various sensors disposed in the image forming apparatus. For example, the control unit 200 is configured to judge the timing for feeding a sheet, and is configured to turn on and off of electricity supply to the heater 22 or switching of the switches 251A and 251C, based on detection results of a sensor disposed at an inlet or outlet of the fixing nip N.

When voltage is applied to the first electrode unit 61A and the second electrode unit 61B, the resistance heating elements 59 excluding the resistance heating elements 59 aligned at the both ends are each energized so that only the first heating unit 60A generates heat. When voltage is applied to the second electrode unit 61B and the third electrode unit 61C, the resistance heating element 59 aligned at the both ends are each energized so that only the second heating unit 60B generates heat. Moreover, the resistance heating elements 59 of both the first heating unit 60A and the second heating unit 60B (i.e., all of the resistance heating elements 59) generate heat when voltage is applied to all of the electrode units 61A to 61C. When a sheet having a relatively small width size, such as A4 size (feeding width: 210 mm) or smaller, is fed, for example, only the first heating unit 60A is driven to generate heat. When a sheet having a relatively large width size, such as greater than A4 size (feeding width: 210 mm) or smaller, is fed, in addition to the first heating unit 60A, the second heating unit 60B is driven to generate heat to generate a heat generating region corresponding to the sheet width.

The image forming apparatus including the fixing device equipped with the above-described planar heater can prevent uneven gloss of an image as the above-described toner is used, and the above-descried heating operation with the planar heater is performed.

Moreover, a highly heat conductive member serving as a member for making the temperature of the fixing belt 20, the heater 22, etc. even over the longitudinal direction may be disposed. In the present disclosure, specifically, the heater 22 may be disposed as a planar member directly heating the fixing belt 20 as in the above-described embodiment, the heater may indirectly heat the fixing belt 20 via the soaking plate 38 serving as a planar member as described below. With the structure where the soaking plate 38 serving as the planar member is indirectly heat the fixing belt 20, the toner on a sheet can be uniformly heated across the longitudinal direction, and the “quantity of heat the toner receives” of the formula (5) can be made uniform. Accordingly, the toner temperature can be made uniform, and uneven gloss of an image can be prevented.

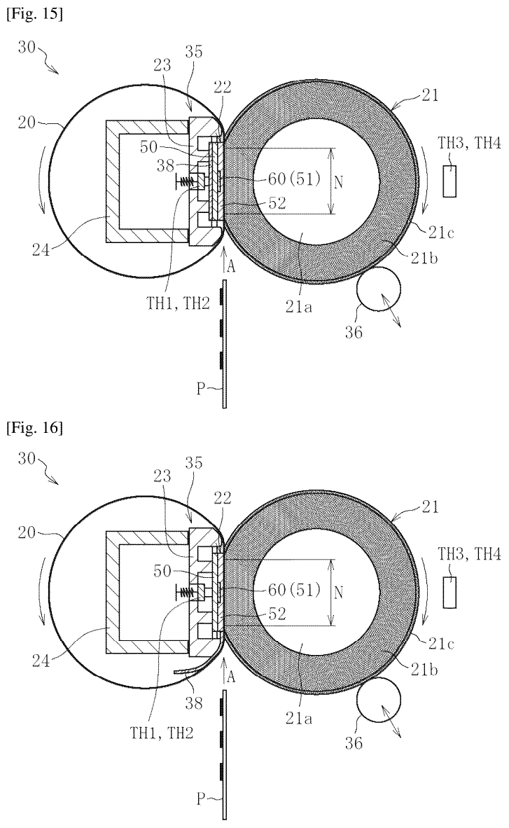

As illustrated in FIG. 15, for example, in the present embodiment, a soaking plate 38 serving as a highly heat conductive member is disposed between the heater holder 23 and the base 50 of the heater 22. The soaking plate 38 is formed of a material having the higher thermal conductivity than the thermal conductivity of the base 50. For example, the material of the soaking plate 38 is preferably copper or aluminium because of high thermal conductivity and low cost.

The soaking plate 38 is extended along the longitudinal direction, and is in contact with the base 50 across the longitudinal direction, particularly across the below-mentioned heating region that is a region where the resistance heating elements 59 are disposed. As a result, the temperature of the heater 22 is made uniform across the longitudinal direction, and variations in the temperature of the heater 22, and also the temperature of the fixing belt 20 across the longitudinal direction can be prevented.

The first thermistor TH1 and the second thermistor TH2 are brought into contact with the soaking plate 38 to detect a temperature of the soaking plate 38. In this case, the temperatures of the first thermistor TH1 and the second thermistor TH2 do not increase rapidly compared with the case where the first thermistor TH1 and the second thermistor TH2 directly detect a temperature of the heater 22. Accordingly, the fixing device 30 is prevented from being cooled as a result that the interval between feeding of sheets is set excessively long, and thus the operation speed of the fixing device 30 can be increased.

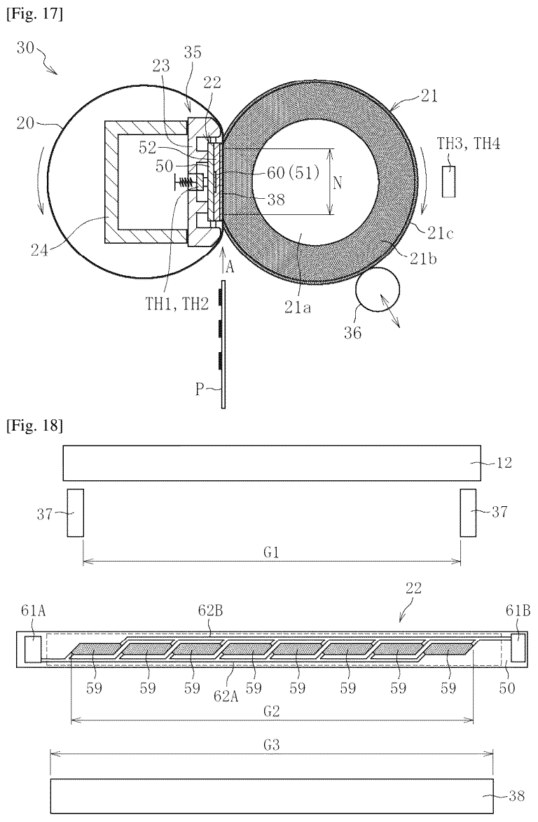

As illustrated in FIG. 16, moreover, a soaking plate 38 may be disposed to be in contact with the inner circumferential surface of the fixing belt 20. The soaking plate 38 of the present disclosure is formed into a cross-sectional arc shape matching with the inner circumferential surface of the fixing belt 20. The soaking plate 38 comes into contact with the inner side of the fixing belt 20 at upstream of the circumferential direction of the fixing belt 20 relative to the fixing nip N. As illustrated in FIG. 17, moreover, a soaking plate 38 may be disposed between the heater 22 and the inner circumferential surface of the fixing belt 20. In the present embodiment, the temperature of the fixing belt 20 is made uniform across the longitudinal direction by the soaking plate 38 so that variation in the temperature of the fixing belt 20 can be prevented.

Particularly, as illustrated in FIG. 18, the region G3 of the soaking plate 38 across the longitudinal direction is arranged to cover the entire region of the image formation region G1 and the heating region G2 of the resistance heating elements 59. As a result, the temperature is made uniform and variations in the temperature thereof are prevented across the entire region of the image formation region G1 or the heating region G2. Particularly in the present embodiment, the image formation region G1 is greater than the heating region G2, and the heating region G2 is greater than the region G3. The heating region G2 is a main heating region of the heater 22, and is a region from one end of the resistance heating element 59 disposed at the outermost end relative to the longitudinal direction to the other end of the resistance heating element 59 disposed at the other outermost end relative to the longitudinal direction.

In the present embodiment, the image formation region G1 is a region between the edge seals 37 disposed at both ends of the developing roller 12 relative to the axial direction (i.e., the above-described longitudinal direction).

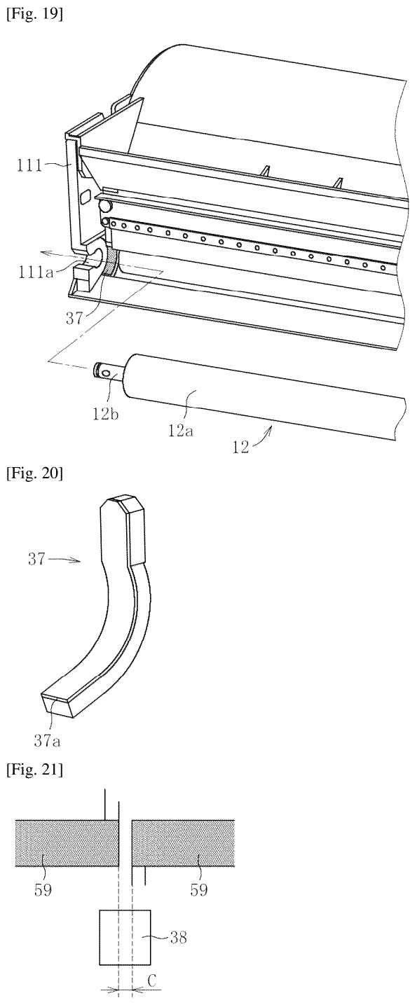

As illustrated in FIG. 19, the developing roller 12 includes an axis 12a and a roller 12b. One end of the developing roller 12 relative to the axial direction is inserted into a hole 111a of the developer container 111 (see the direction indicated with the broken line arrow in FIG. 19). As a result, the developing roller 12 is rotatable held in the developer container 111.

Edge seals 37 are bonded to the areas of the developer container 111 (see the hatched areas in FIG. 19) corresponding to the both ends of the roller 12b, respectively. The edge seals 37 are compressed by the roller 12b to be disposed between the developer container 111 and the ends of the roller 12b to seal the gap between the developer container 11 and the ends of the roller 12b when the developing roller 12 is inserted into the developer container 111. As a result, the toner is prevented from leaking out of the developer container 111 to outside. As illustrated in FIG. 20, a contact surface 37a of the edge seal 37 is pressed against the end part of the roller 12b.

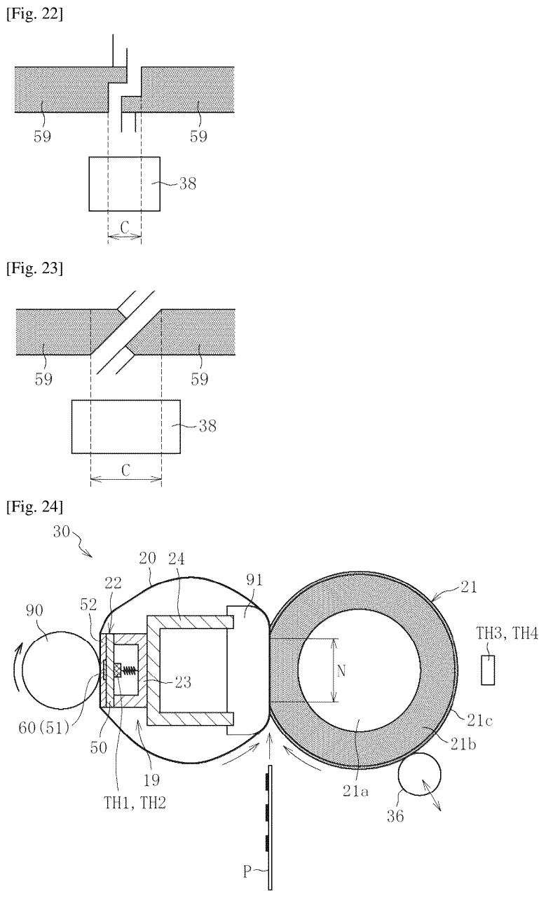

The soaking plate 38 may be partially disposed across the longitudinal direction. As illustrated in FIG. 21, for example, the soaking plate 38 may be disposed in the position corresponding to the divided region C of the resistance heating elements 38 relative to the longitudinal direction. Particularly in FIG. 21, the soaking plate 38 is disposed along the entire region corresponding to the divided region C and is disposed to overlap with the divided region C. The quantity of heat of the heater 22 is smaller at the divided region C than any other heating regions. When the soaking plate 38 is brought into contact with the base 50 or the fixing belt 20 at the position corresponding to the divided region C relative to the longitudinal direction, accordingly, heat transfer from other areas to the divided region C is accelerated, and variations in the temperature of the heater 22 or the fixing belt 20 across the longitudinal direction can be prevented. The divided region C is a region in the longitudinal direction including the entire area at which the resistance heating elements 59 are divided. In the present embodiment, moreover, the divided region C is arranged to be horizontal to the shorter direction of the heater 22 (the up-down direction of FIG. 21). However, the divided region C may be arranged to be inclined relative to the shorter direction of the heater 22 as illustrated in FIG. 23, or may be arranged to be bent at the middle relative to the longitudinal direction of the heater 22 as illustrated in FIG. 22.

Moreover, the present disclosure can be applied for, as well as the above-described fixing device, the fixing devices as illustrated in FIGS. 24 to 26. The structure of each of the fixing devices of FIGS. 24 to 26 will be simply described hereinafter.

First, the fixing device 30 illustrated in FIG. 24 includes a press roller 90 disposed to face the side of the fixing belt 20 opposite to the side thereof where the press roller 21 is disposed, and the fixing device 30 is configured to nip and heat the fixing belt 20 with the press roller 90 and the heater 22. Meanwhile, a nip forming member 91 is disposed against the inner circumference of the fixing belt at the side of the press roller 21. The nip forming member 91 is supported by the stay 24, and the fixing belt 20 is nipped between the nip forming member 91 and the press roller 21 to form a fixing nip N.

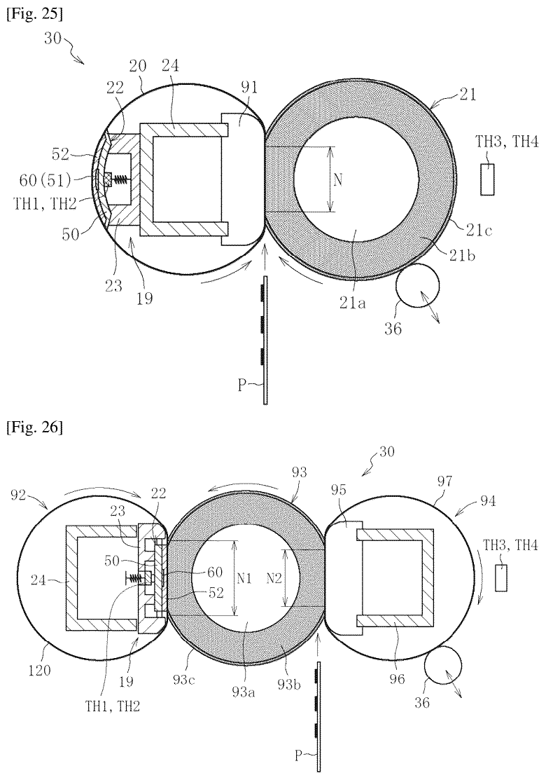

Next, the fixing device 30 illustrated in FIG. 25 does not include the above-described press roller 90, and the heater 22 is formed into an arc-shape to match with the curvature of the fixing belt 20. Other structural components of the fixing device 30 are identical to the fixing device 30 illustrated in FIG. 24.

Finally, the fixing device 30 illustrated in FIG. 26 will be described. The fixing device 30 includes a heating assembly 92, a fixing roller 93 serving as a fixing member, and a press assembly 94 serving as a counter member.

The heating assembly 92 includes the heater 22 that has been described in the previous embodiment, a heating device 35, and a heating belt 120 serving as a belt member. Moreover, the fixing roller 93 includes a core bar 93a formed of solid iron, an elastic layer 93b formed on a surface of the cored bar 93a, and a release layer 93c formed at the outer side of the elastic layer 93b. Moreover, the press assembly 94 is arranged against the fixing roller 93 at the opposite side to the side where the heating assembly 92 is disposed. The press assembly 94 includes a nip forming member 95 and a stay 96, and includes a press belt 97 rotatable disposed to include the nip forming member 95 and the stay 96 therein. A sheet P is fed into the fixing nip N2 formed between the press belt 97 and the fixing roller 93 to heat and press the sheet P to fix the image.

Unevenness of gloss formed in an image can be suppressed in an image forming apparatus including a fixing device equipped with any of the above-described planar heaters by using the above-described toner, and performing a heating operation using the planar heater.

The embodiments of the present disclosure have been described, but the present disclosure is not limited to the above-described embodiments. Needless to say, various changes can be made as long as the changes do not depart from the spirit of the present disclosure.

The image forming apparatus of the present disclosure is not limited to the monochrome image forming apparatus illustrated in FIG. 1, but the image forming apparatus of the present disclosure may be a color image forming apparatus, a photocopier, a printer, a facsimile, or a multifunction peripheral thereof.

In addition to the sheet P (plain paper), the recording medium may include cardboards, post cards, envelopes, thin paper, coated paper (e.g., coat paper and art paper), tracing paper, transparent plastic sheets (e.g., sheets for overhead projectors (OHP)), plastic films, prepreg, and copper foils.

For example, embodiments of the present disclosure are as follows.
<1> An image forming apparatus including:
a toner; and
a fixing device configured to fix an image formed with the toner on a recording medium,
wherein the fixing device includes a fixing belt that is an endless belt, and a planar member configured to heat the fixing belt, and an environmental fluctuation rate X is 45% or greater but 85% or less, and the environmental fluctuation rate X is represented by:

Environmental fluctuation rate X=(Q1−Q2)/{(Q1+Q2)/2}
where Q1 is a quantity of electric charge of the toner in an environment having a temperature of 10 degrees Celsius and relative humidity of 15%, Q2 is a quantity of electric charge of the toner in an environment having a temperature of 27 degrees Celsius and relative humidity of 80%, and a unit for Q1 and Q2 is u C/g.
<2> The image forming apparatus according to <1>,
wherein the fixing belt includes: a base including a resin material; and a surface layer disposed on or above the base.
<3> The image forming apparatus according to <2>,
wherein the resin material is polyimide.
<4> The image forming apparatus according to <2> or <3>,
wherein the fixing belt further includes an adhesive layer disposed between the surface layer and the base, where only the adhesive layer is present between the surface layer and the base.
<5> The image forming apparatus according to any one of <2> to <4>,
wherein the base of the fixing belt has thermal conductivity of from 0.6 W/mK through 2.0 W/mK.
<6> The image forming apparatus according to any one of <2> to <4>,
wherein the base of the fixing belt has thermal conductivity of from 0.8 W/mK through 1.3 W/mK.
<7> The image forming apparatus according to any one of <1> to <6>,
wherein the fixing belt has a thickness of from 50 micrometers through 100 micrometers.
<8> The image forming apparatus according to any one of <1> to <7>,
wherein the fixing device further includes a press member configured to form a fixing nip between a fixing belt and the press member, the planar member includes a resistance heating element, and at an arbitrary position across a longitudinal direction of the planar member, a width of the fixing nip along a conveyance direction of a recording medium is greater than a width of the resistance heating element along the conveyance direction of the recording medium.
<9> The image forming apparatus according to <8>,
wherein in an entire region across the longitudinal direction of the fixing nip, the width of the fixing nip along the conveyance direction of the recording medium is greater than the width of the resistance heating element along the conveyance direction of the recording medium.
<10> The image forming apparatus according to any one of <1> to <9>,
wherein a lubricant is disposed between the fixing belt and the planar member,
the fixing belt has a sliding surface, and the planar member has a sliding surface, where the sliding surface of the fixing belt and the sliding surface of the planar member are slide against each other, and
surface roughness of the sliding surface of the fixing belt is greater than surface roughness of the sliding surface of the planar member.
<11> The image forming apparatus according to any one of <1> to <9>,
wherein a lubricant is disposed between the fixing belt and the planar member,
the fixing belt has a sliding surface, and the planar member has a sliding surface, where the sliding surface of the fixing belt and the sliding surface of the planar member are slide against each other, and
skewness of a roughness curve of the sliding surface of the fixing belt is greater than skewness of a roughness curve of the sliding surface of the planar member.
<12> The image forming apparatus according to any one of <1> to <11>,
wherein the planar member includes a plurality of resistance heating elements, and
the resistance heating elements are electrically connected in parallel to exhibit characteristics of a positive temperature coefficient.
<13> The image forming apparatus according to any one of <1> to <12>,
wherein the planar member includes a plurality of heating units each including one or more resistance heating elements, and the heating units are each independently controlled.
<14> The image forming apparatus according to any one of <1> to <13>,
wherein the planar member includes a base, and
the fixing device further includes a highly heat conductive member having thermal conductivity higher than thermal conductivity of the base of the planar member.
<15> The image forming apparatus according to <14>,
wherein the planer member includes a plurality of the resistance heating elements, and
the highly heat conductive member is disposed in a position that is between the planar member and the fixing belt across the longitudinal direction of the planar member, and corresponds to a divided region that is present between the resistance heating elements.
<16> The image forming apparatus according to <14> or <15>,
wherein the fixing device further includes a temperature sensor member to be in contact with the highly heat conductive member.
<17> The image forming apparatus according to any one of <14> to <16>,
wherein a width of an image formation region is greater than a width of a heating region of the planar member, and the width of the heating region is greater than a width of the highly heat conductive member, where the heating region is a region of the planar member that is from the resistance heating element disposed at outermost end to the resistance heating element disposed at other outermost end, relative to the longitudinal direction of the planar member, and
the width of the image formation region is maximum width of an image formed on the recording medium relative to the longitudinal direction of the planar member.
<18> The image forming apparatus according to any one of <1> to <17>,
wherein the fixing device further includes a plurality of temperature sensor members, and
the temperature sensor members are disposed at an inner side and outer side of a region with respect to the longitudinal direction of the planer member, and the region is a region where a recording medium having minimum width corresponding to the fixing device is passed through.
<19> The image forming apparatus according to <18>, wherein duration of the recording medium passing through the fixing nip is from 25 msec through 38 msec.
<20> The image forming apparatus according to any one of <1> to <19>,
wherein the environmental fluctuation rate X is 45% or more but 65% or less.
<21> The image forming apparatus according to any one of <1> to <20>,
wherein the toner includes toner particles, each toner particle having a shell layer.
<22> The image forming apparatus according to any one of <1> to <21>,
wherein the endless belt of the fixing belt has an inner diameter of from mm through 40 mm.
<23> The image forming apparatus according to any one of <1> to <22>,
wherein the planar member has a thickness of from 0.5 mm through 2.0 mm.

### REFERENCE SIGNS LIST

1: image forming apparatus
12: developing roller (developer bearing member)
20: fixing belt (fixing member or rotating member)
20a: sliding surface
21: press roller (press member or counter member)
22: heater (planar member)
22a: sliding surface
23: heater holder (holding member)
30: fixing device
36: soaking roller (highly heat conductive member)
38: soaking plate (planar member or highly heat conductive member)
59: resistance heating element
60: heating unit
A: sheet conveyance direction (conveyance direction of recording medium)
B: longitudinal direction
C: divided region of resistance heating elements
G1: width of image formation region
G2 width of heating region by resistance heating element
G3: width of soaking plate relative to longitudinal direction
N: fixing nip
P: sheet (recording medium)
S: width of resistance heating element along sheet conveyance direction
TH1 to TH4: thermistor (temperature sensor member)

1. An image forming apparatus comprising:
a toner; and
a fixing device configured to fix an image formed with the toner on a recording medium,
wherein the fixing device includes a fixing belt that is an endless belt, and a planar member configured to heat the fixing belt, and
an environmental fluctuation rate X is 45% or greater but 85% or less, and the environmental fluctuation rate X is represented by:
Environmental fluctuation rate X=(Q1−Q2)/{(Q1+Q2)/2}
where Q1 is a quantity of electric charge of the toner in an environment having a temperature of 10 degrees Celsius and relative humidity of 15%, Q2 is a quantity of electric charge of the toner in an environment having a temperature of 27 degrees Celsius and relative humidity of 80%, and
a unit for Q1 and Q2 is μC/g.

2. The image forming apparatus according to claim 1,
wherein the fixing belt includes: a base including a resin material; and a surface layer disposed on or above the base.

3. The image forming apparatus according to claim 2,
wherein the resin material is polyimide.

4. The image forming apparatus according to claim 2,
wherein the fixing belt further includes an adhesive layer disposed between the surface layer and the base, where only the adhesive layer is present between the surface layer and the base.

5. The image forming apparatus according to claim 2,
wherein the base of the fixing belt has thermal conductivity of from 0.6 W/mK through 2.0 W/mK.

6. The image forming apparatus according to claim 2,
wherein the base of the fixing belt has thermal conductivity of from 0.8 W/mK through 1.3 W/mK.

7. The image forming apparatus according to claim 1,
wherein the fixing belt has a thickness of from 50 micrometers through 100 micrometers.

8. The image forming apparatus according to claim 1,
wherein the fixing device further includes a press member configured to form a fixing nip between a fixing belt and the press member,
the planar member includes a resistance heating element, and
at an arbitrary position across a longitudinal direction of the planar member, a width of the fixing nip along a conveyance direction of a recording medium is greater than a width of the resistance heating element along the conveyance direction of the recording medium.

9. The image forming apparatus according to claim 8,
wherein in an entire region across the longitudinal direction of the fixing nip, the width of the fixing nip along the conveyance direction of the recording medium is greater than the width of the resistance heating element along the conveyance direction of the recording medium.

10. The image forming apparatus according to claim 1,
wherein a lubricant is disposed between the fixing belt and the planar member, the fixing belt has a sliding surface, and the planar member has a sliding surface, where the sliding surface of the fixing belt and the sliding surface of the planar member are slide against each other, and
surface roughness of the sliding surface of the fixing belt is greater than surface roughness of the sliding surface of the planar member.

11. The image forming apparatus according to claim 1,
wherein a lubricant is disposed between the fixing belt and the planar member, the fixing belt has a sliding surface, and the planar member has a sliding surface, where the sliding surface of the fixing belt and the sliding surface of the planar member are slide against each other, and
skewness of a roughness curve of the sliding surface of the fixing belt is greater than skewness of a roughness curve of the sliding surface of the planar member.

12. The image forming apparatus according to claim 1,
wherein the planar member includes a plurality of resistance heating elements, and the resistance heating elements are electrically connected in parallel to exhibit characteristics of a positive temperature coefficient.

13. The image forming apparatus according to claim 1,
wherein the planar member includes a plurality of heating units each including one or more resistance heating elements, and
the heating units are each independently controlled.

14. (canceled)

15. (canceled)

16. (canceled)

17. The image forming apparatus according to claim 14,
wherein a width of an image formation region is greater than a width of a heating region of the planar member, and the width of the heating region is greater than a width of the highly heat conductive member, where the heating region is a region of the planar member that is from the resistance heating element disposed at outermost end to the resistance heating element disposed at other outermost end, relative to the longitudinal direction of the planar member, and
the width of the image formation region is maximum width of an image formed on the recording medium relative to the longitudinal direction of the planar member.

18. The image forming apparatus according to claim 1,
wherein the fixing device further includes a plurality of temperature sensor members, and
the temperature sensor members are disposed at an inner side and outer side of a region with respect to the longitudinal direction of the planer member, and the region is a region where a recording medium having minimum width corresponding to the fixing device is passed through.

19. The image forming apparatus according to claim 8,
wherein duration of the recording medium passing through the fixing nip is from 25 msec through 38 msec.

20. The image forming apparatus according to claim 1,
wherein the environmental fluctuation rate X is 45% or more but 65% or less.

21. The image forming apparatus according to claim 1,
wherein the toner includes toner particles, each toner particle having a shell layer.

22. The image forming apparatus according to claim 1,
wherein the endless belt of the fixing belt has an inner diameter of from 15 mm through 40 mm.

23. The image forming apparatus according to claim 1,
wherein the planar member has a thickness of from 0.5 mm through 2.0 mm.
